(19) United States
(12) Patent Application Publication
(10) Pub. No.: US 2017/0178390 A1
(43) Pub. Date: Jun. 22, 2017

(54) DEVICES, SYSTEMS, AND METHODS FOR MEASURING AND RECONSTRUCTING THE SHAPES OF SPECULAR OBJECTS BY MULTIVIEW CAPTURE

(71) Applicant: CANON KABUSHIKI KAISHA, Tokyo (JP)

(72) Inventors: Jinwei Ye, San Jose, CA (US); Siu-Kei Tin, Milpitas, CA (US); Can Chen, Santa Clara, CA (US); Mahdi Nezamabadi, San Jose, CA (US)

(21) Appl. No.: 15/372,263

(22) Filed: Dec. 7, 2016

Related U.S. Application Data
(60) Provisional application No. 62/269,855, filed on Dec. 18, 2015.
(60) Provisional application No. 62/335,513, filed on May 12, 2016.

(51) Int. Cl. G06T 15/20; G06T 15/50; G06T 15/06

(52) U.S. Cl. CPC G06T 15/20; G06T 15/06; G06T 15/506; G06T 2215/16

(57) ABSTRACT

Devices, systems, and methods obtain two sets of images of an object, each of which was captured from a respective viewpoint; identify pixel regions in the two sets of images that show reflections from a light-modulating device that were reflected by a surface of the object; calculate respective surface normals for points on the surface in the pixel regions; calculate, for each viewpoint, respective unscaled surface coordinates of the points based on the respective surface normals; calculate, for each viewpoint, a respective initial scale factor based on the respective surface normals and on decoded light-modulating-device-pixel indices; calculate, for each viewpoint, scaled surface coordinates of the points based on the respective initial scale factor and the respective unscaled surface coordinates of the viewpoint; and calculate, for each viewpoint, a respective refined scale factor by minimizing discrepancies among the scaled surface coordinates of the points on the surface.

### CROSS-REFERENCE TO RELATED APPLICATIONS

This application claims the benefit of U.S. Provisional Application No. 62/269,855, which was filed on Dec. 18, 2015, and U.S. Provisional Application No. 62/335,513, which was filed on May 12, 2016.

### BACKGROUND

Technical Field

This application generally relates to measuring and reconstructing the shapes of physical objects, including objects that have specular surfaces.

Background

Objects that are composed of a highly-glossy material, such as specular objects, have reflection characteristics that differ significantly from objects that are composed of a diffuse material. For example, a diffuse material reflects light from a directional light source, such as a projector, in virtually all directions, but a highly-glossy material reflects light primarily in only one direction or a few directions. These reflections from a highly-glossy material are specular reflections and are caused by the shiny surface of the highly-glossy material, which often has a mirror-like surface finish.

### SUMMARY

Some embodiments of a method comprise the following: obtaining two sets of images of an object, each of which was captured from a respective viewpoint, wherein the viewpoints partially overlap; identifying pixel regions in the two sets of images that show reflections from a light-modulating device that were reflected by a surface of the object; calculating respective surface normals for points on the surface of the object in the pixel regions in the two sets of images, wherein at least some of the points on the surface of the object are shown in both of the two sets of images; calculating, for each viewpoint of the two viewpoints, respective unscaled surface coordinates of the points on the surface of the object based on the respective surface normals; calculating, for each viewpoint of the two viewpoints, a respective initial scale factor based on the respective surface normals and on decoded light-modulating-device-pixel indices; calculating, for each viewpoint of the two viewpoints, initial scaled surface coordinates of the points on the surface of the object based on the respective initial scale factor of the viewpoint and the respective unscaled surface coordinates of the viewpoint; and calculating, for each viewpoint of the two viewpoints, a respective refined scale factor by minimizing discrepancies among the initial scaled surface coordinates of the points on the surface of the object that are shown in both of the two sets of images.

Some embodiments of a system comprise one or more computer-readable media and one or more processors that are coupled to the one or more computer-readable media. The one or more processors are configured to cause the system to obtain a first set of images of an object that was captured from a first viewpoint, obtain a second set of images of the object that was captured from a second viewpoint, calculate first respective surface normals for points on a surface of the object that are shown in the first set of images, calculate second respective surface normals for points on the surface of the object that are shown in the second set of images, wherein at least some of the points on the surface of the object are shown in both the first set of images and the second set of images, calculate, for each viewpoint of the two viewpoints, respective unscaled surface coordinates of the points on the surface of the object based on the respective surface normals; calculate, for the first viewpoint, first initial scaled surface coordinates of the points on the surface of the object that are shown in the first set of images based on the first respective surface normals and on a first initial scale factor, calculate, for the second viewpoint, second initial scaled surface coordinates of the points on the surface of the object that are shown in the second set of images based on the second respective surface normals and on a second initial scale factor, and calculate a first refined scale factor and a second refined scale factor by minimizing differences between the first initial scaled surface coordinates and the second initial scaled surface coordinates of the points on the surface of the object that are shown in both the first set of images and the second set of images.

Some embodiments of one or more computer-readable storage media store computer-executable instructions that, when executed by one or more computing devices, cause the one or more computing devices to perform operations that comprise the following: obtaining a first set of images of an object that was captured from a first viewpoint; obtaining a second set of images of the object that was captured from a second viewpoint; calculating first respective surface normals for points on a surface of the object that are shown in the first set of images; calculating second respective surface normals for points on the surface of the object that are shown in the second set of images, wherein at least some of the points on the surface of the object are shown in both the first set of images and the second set of images; calculating, for the first viewpoint, first initial scaled surface coordinates of the points on the surface of the object that are shown in the first set of images based on the first respective surface normals and on a first initial scale factor; calculating, for the second viewpoint, second initial scaled surface coordinates of the points on the surface of the object that are shown in the second set of images based on the second respective surface normals and on a second initial scale factor; and calculating a first refined scale factor and a second refined scale factor by minimizing differences between the first initial scaled surface coordinates and the second initial scaled surface coordinates of the points on the surface of the object that are shown in both the first set of images and the second set of images.

### BRIEF DESCRIPTION OF THE DRAWINGS

FIG. 1 illustrates an example embodiment of a system for measuring the shapes of objects.

FIG. 2 illustrates an example embodiment of an operational flow for measuring and reconstructing the shape of an object.

FIG. 3 illustrates the notation that is used to describe an example embodiment of normal-field integration that uses a perspective camera model.

FIG. 4A is a conceptual illustration of back-tracing light rays from a camera.

FIG. 4B is a conceptual illustration of varying a scale factor.

FIG. 4C illustrates an example of a comparison of a surface at a candidate scale factor to a measured surface.

FIG. 5 illustrates an example embodiment of the relationship between weighted pixel differences and different scale factors for an objective function.

FIG. 6 illustrates an example embodiment of the relationships between the outputs of an objective function and different scale factors.

FIG. 7 is a conceptual illustration of an example embodiment of multi-view scale refinement.

FIG. 8 illustrates an example embodiment of an operational flow for decoding an image of an object.

FIG. 9A illustrates an example embodiment of an image of an object.

FIG. 9B illustrates example embodiments of index maps of the image of the object in FIG. 9A.

FIG. 10A illustrates an example embodiment of an image of an object.

FIGS. 10B-10C illustrate example embodiments of image masks.

FIG. 11A illustrates an example embodiment of a window.

FIG. 11B is a conceptual illustration of an example embodiment of multi-view scale refinement with an objective function.

FIG. 12 illustrates an example embodiment of overlapped regions between two windows, as shown by their respective masks.

FIG. 13A illustrates example embodiments of refined surface coordinates and merged surface coordinates.

FIG. 13B shows the errors in distance and surface normals in the overlap of the surface coordinates of FIG. 13A.

FIG. 14 illustrates example embodiments of an object, the surface coordinates from different views of the object, and merged surface coordinates.

FIG. 15 illustrates example embodiments of an object and refined merged surface coordinates.

FIG. 16 illustrates example embodiments of objects and refined merged surface coordinates.

FIG. 17 illustrates example embodiments of a surface, a representation of the surface that was generated using an orthographic-camera model, and a representation of the surface that was generated using a perspective-camera model.

FIG. 18 illustrates example embodiments of light-modulating devices and a light source.

FIG. 19 illustrates example embodiments of light-modulating devices, an object, an effective light field, and a bounding volume.

FIG. 20 is a conceptual illustration of the geometry of an example embodiment of a binary-code projection.

FIG. 21 illustrates an example embodiment of a system for measuring the shapes of objects.

### DETAILED DESCRIPTION

The following paragraphs describe certain explanatory embodiments. Other embodiments may include alternatives, equivalents, and modifications. Additionally, the explanatory embodiments may include several novel features, and a particular feature may not be essential to some embodiments of the devices, systems, and methods that are described herein.

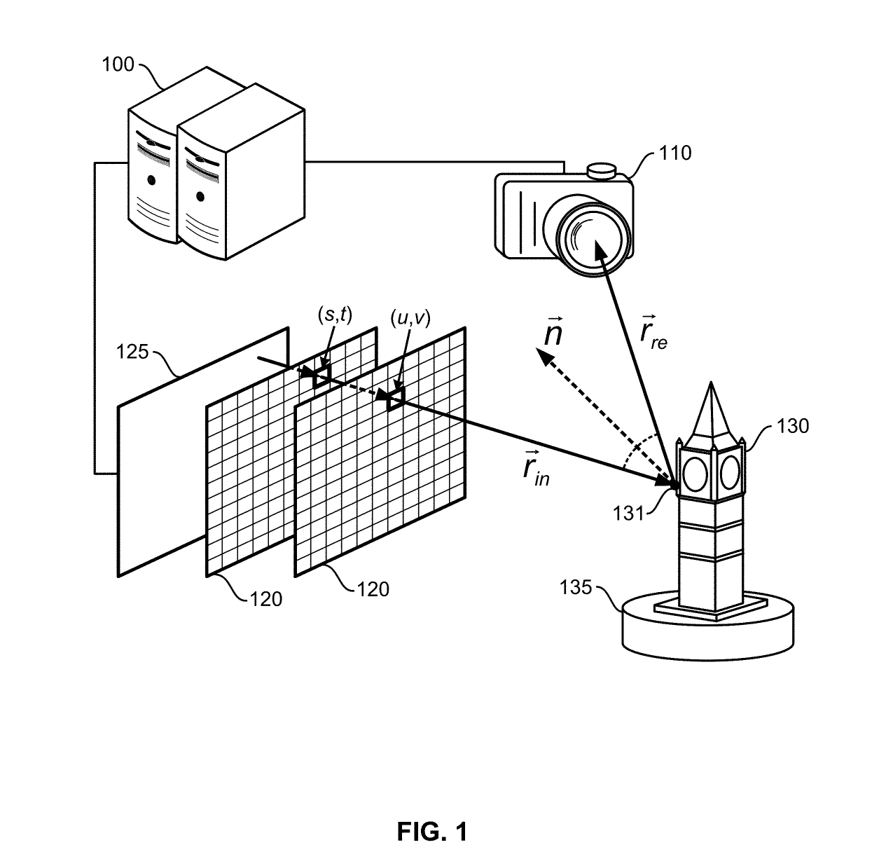

FIG. 1 illustrates an example embodiment of a system for measuring the shapes of objects (also referred to herein as a “measurement system”). The measurement system includes one or more measurement devices 100, each of which is a specially-configured computing device (e.g., a desktop computer, a laptop computer, a server); one or more image-capturing devices 110; two or more light-modulating devices (LMDs) 120; and one or more light sources 125. The measurement system generates a digital representation of the shape of an object 130, and the object 130 may be a specular object. The digital representation is a reconstruction of the object 130, and the digital representation may represent the object 130 with a set of three-dimensional points (e.g., a point cloud) or a set of surface normals (also referred to herein as a “normal field”). For example, FIG. 1 illustrates the surface normal n of a point 131 on the surface of the object 130.

In this embodiment, the light-modulating devices 120 are electronically-controllable light-modulating panels. An example of an electronically-controllable light-modulating panel is a liquid-crystal-display (LCD) panel, which has programmable pixels that modulate a backlight. Another example of an electronically-controllable light-modulating panel is electrochromic glass. Electrochromic glass includes a layer that has light-transmission properties that are switchable between a transparent mode, in which the layer is completely transparent or nearly-completely transparent, and a diffuse mode, in which the layer assumes a frosted or opaque appearance. Images can be projected or formed on the frosted or opaque appearance of the diffuse mode.

The light source 125 may provide continuous area illumination, for example when the light source 125 is a panel that is composed of a high density of light-producing pixels. In some embodiments, the light source 125 is a backlight from a common display device. Also, in some embodiments, the light source 125 is an imaging projector that has programmable luminous pixels.

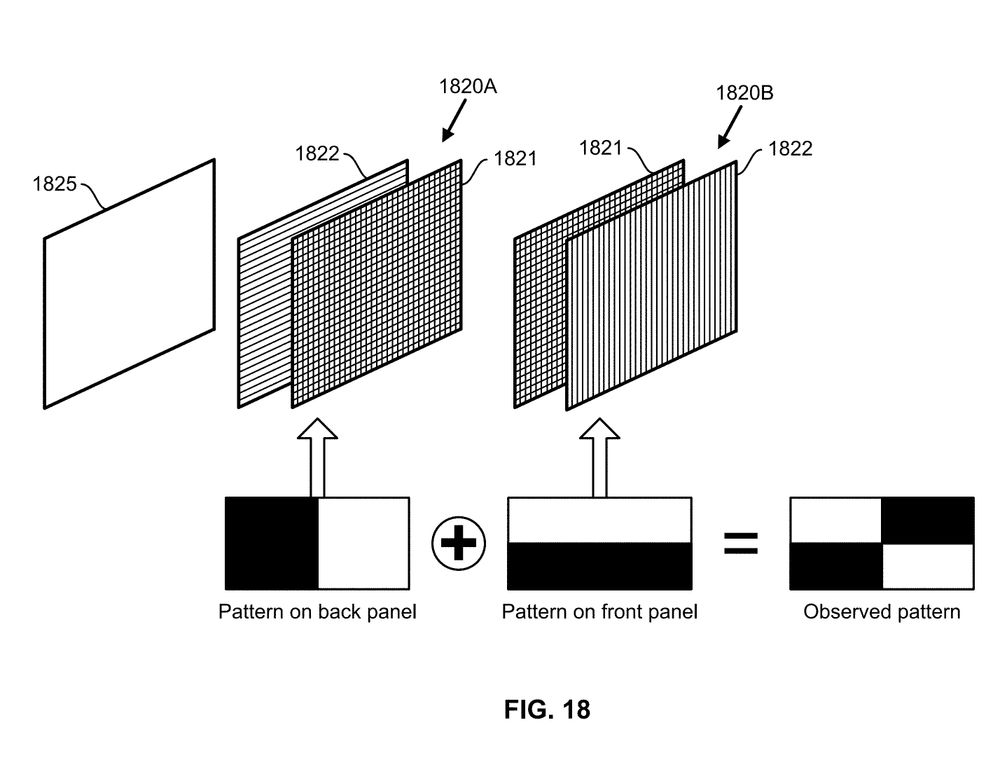

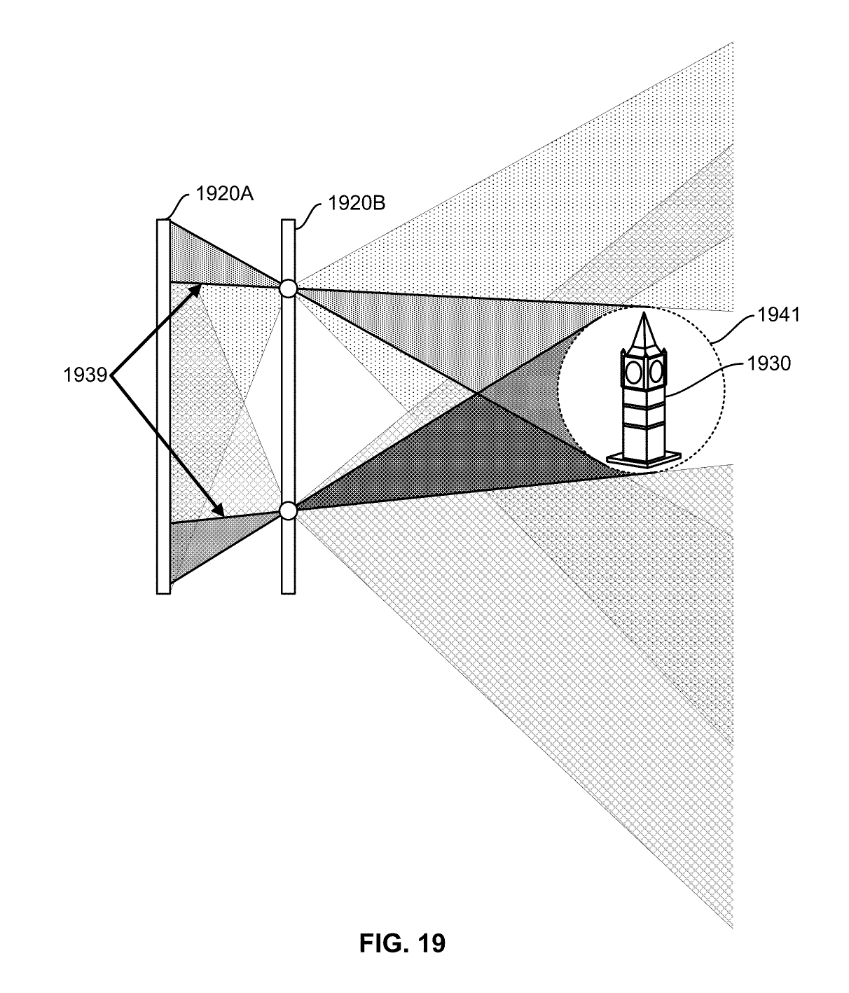

The light source 125 and the light-modulating devices 120 output light rays \vec{r}. As described herein, a light ray \vec{r} includes two components: an illumination light ray \vec{r}ᵢₙ that travels from the light source 125 through the light-modulating devices 120 to the surface of the object 130, and a reflected light ray \vec{r}ᵣₑ that is the reflection of the illumination light ray \vec{r}ᵢₙ from the surface of the object 130. Each light ray \vec{r}₁ its illumination light ray \vec{r}ᵢₙ, and its reflected light ray \vec{r}ᵣₑ may be described or identified by the intersections of the illumination light ray \vec{r}ᵢₙ with the two light-modulating devices 120 (a light ray \vec{r} is described by [u, v] and [s, t] in FIG. 1). Also, the light source 125 and the light-modulating devices 120 may output illumination light rays \vec{r}ᵢₙ in one or more illumination patterns, for example as shown in FIG. 18. An illumination pattern may code a sparse subset of the set of light rays that can be generated by the light source 125 and the light-modulating devices 120 to those light rays that can actually reach the object 130 or a bounding volume around the object 130, for example as shown in FIG. 19.

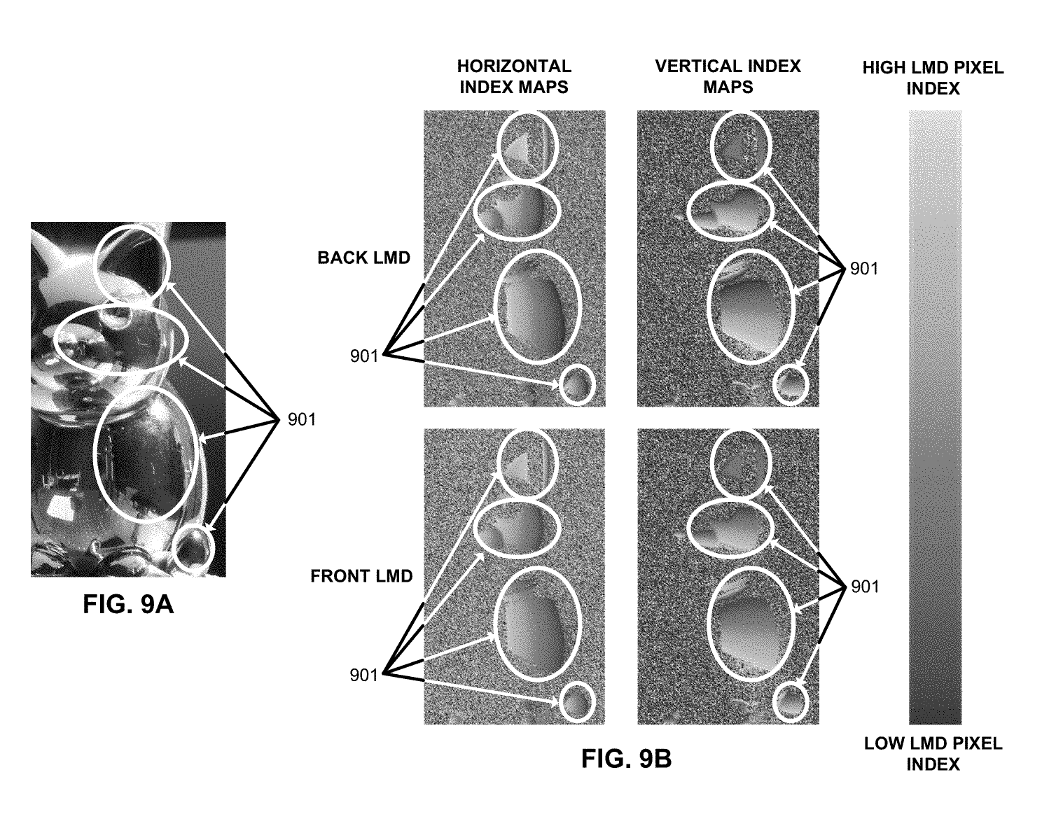

The image-capturing device 110 captures the reflected light rays \vec{r}ᵣₑ. In FIG. 1, the image-capturing device 110 captures the reflected light ray \vec{r}ᵣₑ, which is the illumination light ray \vec{r}ᵢₙ that is reflected from a point 131 on the surface of the object 130. The image-capturing device 110 generates an image from the captured reflected light rays \vec{r}ᵣₑ. A light-modulating-device-pixel index (LMD-pixel index) of the region (e.g., one pixel, a set of pixels) in the image of the object 130 that captured the light from the point 131 describes the two LMD pixels that transmitted the light ray \vec{r} between the light source 125 and the point 131. In this example, the LMD-pixel index includes (s, t) and (u, v) in the region of the image that includes the point 131. The LMD-pixel indices of an image may be represented by one or more index maps, for example by four index maps as shown in FIG. 9B. FIG. 1 also illustrates the surface normal \vec{n} of the point 131 on the surface of the object 130 that reflected the illumination light ray \vec{r}ᵢₙ.

Furthermore, because information about the shape of the object 130 is obtained by capturing reflections from it, and because the reflections are viewpoint dependent, in order to recover the full surface of an object 130, the measurement system can observe the object's reflections from multiple points of view (viewpoints), for example by using one or more additional cameras 110 or by observing the object 130 in different poses (e.g., by rotating the object). In the example embodiment of FIG. 1, the object 130 is placed on a rotating stage 135, which is a stage that is capable of rotating, and the object 130 is rotated to capture reflections from the object 130 from multiple viewpoints. Also, some embodiments of the measurement system use curved light-modulating devices 120 to partially or completely surround the object 130 in order to obtain greater reflection coverage.

The system may calibrate the positions of the light-modulating devices 120 and the image-capturing device 110, as well as the rotating stage 135 in embodiments that include the rotating stage 135. In some embodiments, the calibration procedure includes generating one or more transformation matrices. The transformation matrices define a rotation and a translation from an image-capturing device to a rotating stage or to an object, and may also define a rotation and a translation between different poses of the object.

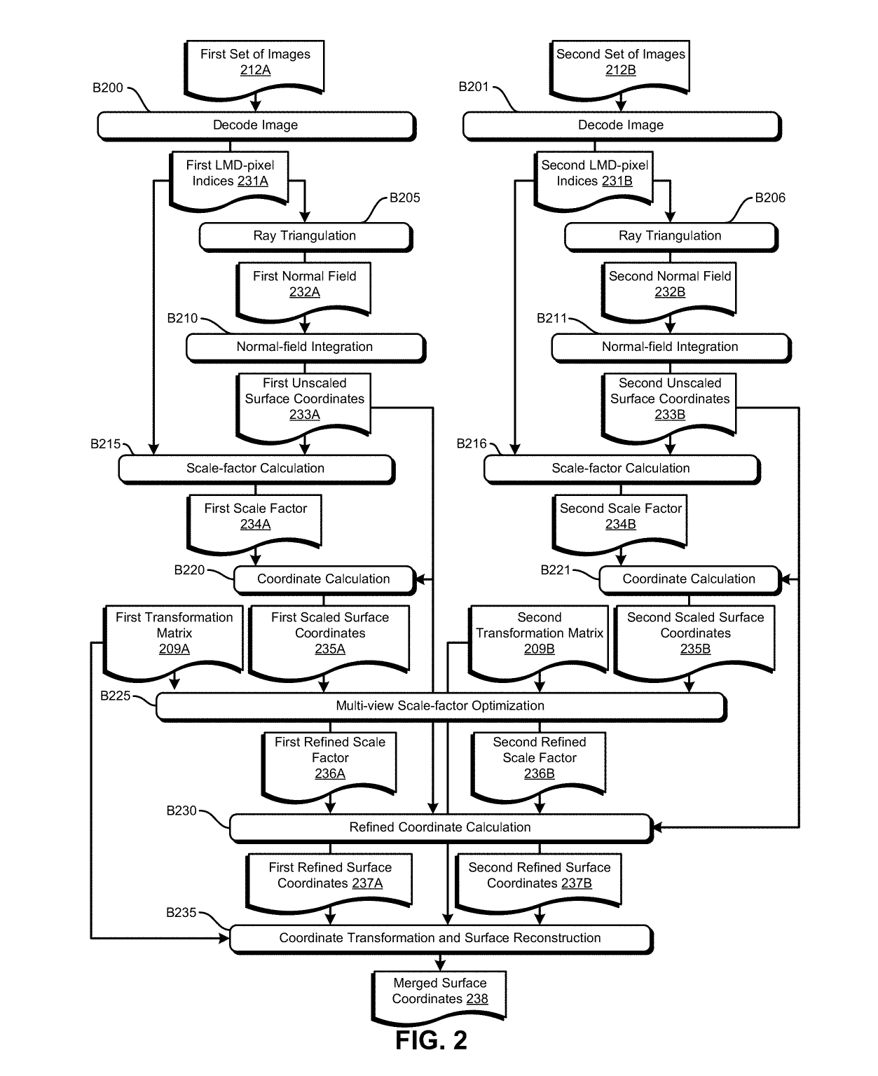

FIG. 2 illustrates an example embodiment of an operational flow for measuring and reconstructing the shape of an object. Although this operational flow and the other operational flows that are described herein are each presented in a certain order, some embodiments of these operational flows may perform at least some of the operations in different orders than the presented orders. Examples of possible different orderings include concurrent, overlapping, reordered, simultaneous, incremental, and interleaved orderings. Thus, other embodiments of the operational flows that are described herein may omit blocks, add blocks, change the order of the blocks, combine blocks, or divide blocks into more blocks.

Furthermore, although this operational flow and the other operational flows that are described herein are performed by a measurement device, other embodiments of these operational flows may be performed by two or more measurement devices or by one or more other specially-configured computing devices.

Moreover, while the embodiment in FIG. 2 uses two sets of images and includes two operational flows, some embodiments of the operational flow use more than two sets of images and include more than two operational flows. The measurement device may perform these two operational flows concurrently or sequentially. Also, “first” and “second” are used to distinguish the two operational flows and do not express or imply any temporal order.

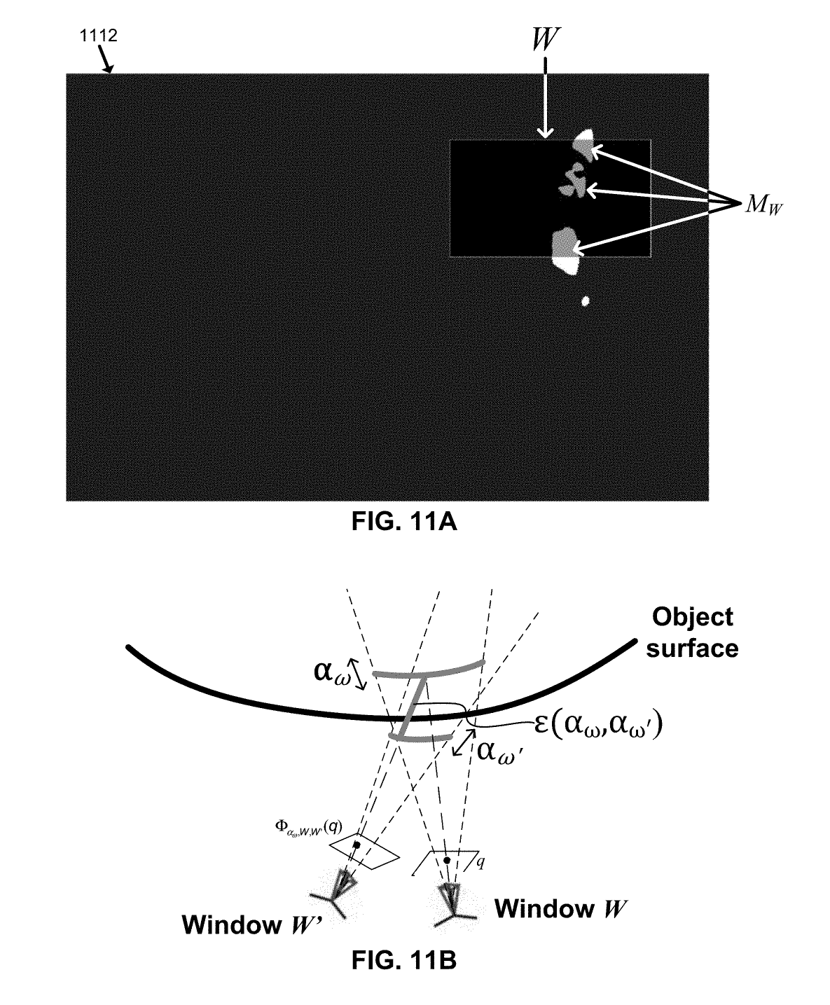

FIG. 2 begins with two operational flows: a first operational flow and a second operational flow, each of which operates on a respective set of images. The two sets of images each present a different viewpoint of an object, and the images in a set of images show the object from the same viewpoint. The images in a set of images capture reflections from the object while the object is illuminated by different patterns from a light source and two or more LMDs. Accordingly, each image in a set of images may capture reflections from the object while the object is illuminated by a pattern from the light source and the LMDs that is different from the patterns that are captured by the other images in the set of images. Also, in some embodiments, each image is a window from a larger image (e.g., the window W in FIG. 11A).

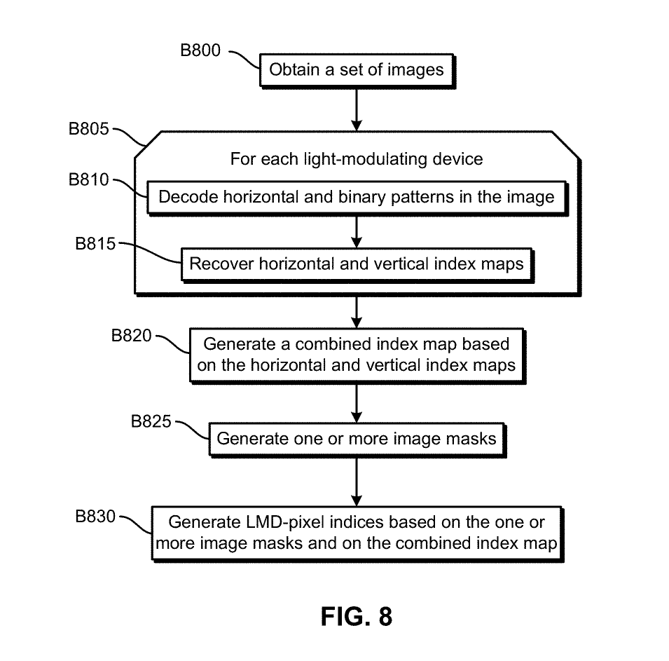

In the first operational flow (“first flow”), in block B200 the measurement device obtains a first set of images 212A of an object, and the measurement device decodes the first set of images 212A, thereby producing the first LMD-pixel indices 231A. Some embodiments of the measurement device implement block B200 (and block B201) by performing the operational flow that is described in FIG. 8.

The first LMD-pixel indices 231A describe, for a region of the images in the first set of images 212A, the two respective pixels of the light-modulating devices (one pixel per light-modulating device) that a respective light ray \vec{r} passed through before it was captured in the region. Furthermore, LMD-pixel indices that are generated by decoding an image may be referred to herein as “measured LMD-pixel indices.” Accordingly, the first LMD-pixel indices 231A are examples of measured LMD-pixel indices.

Next, in block B205, the measurement device performs ray triangulation based on the first LMD-pixel indices 231A to generate a first normal field 232A for the object as the object is shown in the viewpoint of the first set of images 212A (i.e., for the part of the object that is visible from the viewpoint of the first set of images 212A). The first normal field 232A is a collection of the surface normals that are generated by the ray triangulation in block B205. For example, for a particular light ray \vec{r}, the measurement device may triangulate its illumination light ray \vec{r}ᵢₙ and its reflected light ray \vec{r}ᵣₑ to determine the normal of the point on the surface that reflected the light ray \vec{r}.

Also for example, the measurement device may determine the surface normal of the object at each image pixel by performing the following: (1) Fitting a regression line through the LMD-pixel locations in the first LMD-pixel indices 231A. (2) Determining the direction of the light ray as it reached the pixel of the image-capturing device. (3) Determining the surface normal of the object as a half-way vector of the regression line and of the direction of the light ray as it reached the pixel of the image-capturing device.

Thus, the measurement device can calculate a respective surface normal \vec{n} for each point of a plurality of points on the surface of the object based on the direction of the illumination light ray \vec{r}ᵢₙ of the specular reflection at the point and on the direction of the reflected light ray \vec{r}ᵣₑ of the specular reflection at the point. For example, some embodiments calculate the surface normal \vec{n} at a point as described by the following:

$${n}^{->} = \frac{{{r}^{->}}_{in} + {{r}^{->}}_{re}}{‖ {{r}^{->}}_{in} + {{r}^{->}}_{re} ‖} . \qquad ( 1 )$$

The first flow then moves to block B210, where the measurement device performs normal-field integration on the first normal field 232A to generate first unscaled surface coordinates 233A, which are the three-dimensional (3D) coordinates of respective points on the surface of the object, and which collectively describe an integrated surface. Surface coordinates, such as the first unscaled surface coordinates 233A, may be represented by a point cloud. In some embodiments, the measurement device uses an orthographic camera model to generate the first unscaled surface coordinates 233A. And in some embodiments (e.g., embodiments where an image-capturing device has a large field of view, a small focal distance, and a small focal length), the measurement device uses a perspective camera model to generate the first unscaled surface coordinates 233A.

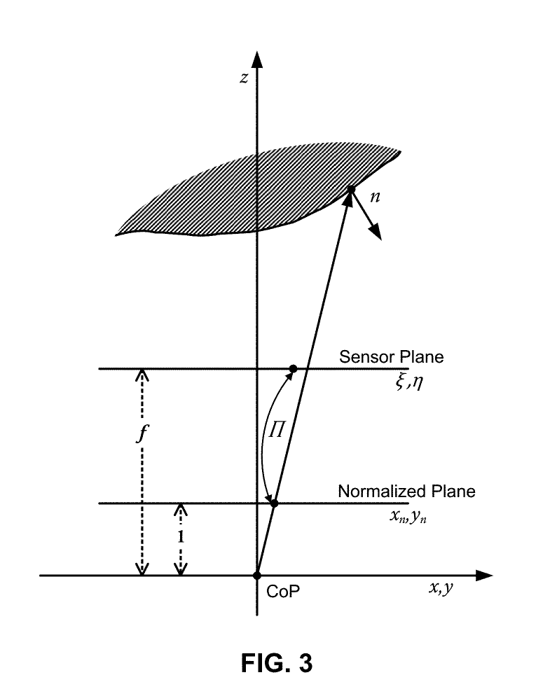

For example, some embodiments of the measurement device perform normal-field integration with a perspective camera model as described by the following, which refers to notation that is illustrated by FIG. 3: Let the origin be the center of projection (CoP) and the focal distance be f. Let (ξ, η) be the image coordinates (e.g., the coordinates of a pixel) on the sensor plane of the image-capturing device, and let (x, y) be the world coordinates in a world-coordinate system.

For each pixel (ξ, η) of a surface z=F(x,y), the normal \vec{n}=(n₁, n₂, n₃) is described by the normal field (e.g., the first normal field 232A). Some embodiments of the measurement device first covert the normals to surface gradients (e.g., according to zₓ=−n₁/n₂ and z_{y}=−n₂/n₃, where zₓ and z_{y} are surface gradients) and then solve the optimal surface using a Poisson technique. However, due to the perspective projection, the world coordinates (x, y, z) of a point on the surface z may not have a linear relationship with the image coordinates (ξ, η) of the point on the surface z. Therefore, the traditional Poisson technique may not be directly applicable. Thus, to integrate the surface z, some embodiments of the measurement device first convert the surface gradients (zₓ and z_{y}) into image coordinates by applying a perspective projection (e.g., x=ξ·z/f, y=η−z/f), for example as described by the following:

$${z}_{ξ} = \frac{{z}_{x}}{f} ( z + {z}_{ξ} \cdot ξ ) + \frac{{z}_{y}}{f} {z}_{ξ} \cdot η , and \\ {z}_{η} = \frac{{z}_{x}}{f} {z}_{η} \cdot ξ + \frac{{z}_{y}}{f} ( z + {z}_{η} \cdot η ) . \qquad ( 2 )$$

However (z_{ξ}, z_{η}) is not directly integrable because z_{ξ} and z_{η} are functions of the surface z itself. The surface z can be eliminated from the expression by substituting the surface z with a new variable t=ln z. For example, some embodiments of the measurement device apply the chain rule as described by the following expression:

$${t}_{ξ} = \frac{{z}_{x}}{f - {z}_{x} ξ - {z}_{y} η} , and \\ {t}_{η} = \frac{{z}_{y}}{f - {z}_{x} ξ - {z}_{y} η} . \qquad ( 3 )$$

Then (t_{ξ}, t_{η}) can be integrated using a standard Poisson technique. The integration produces t=t₀+c for some arbitrary constant c. Exponentiation produces z=α−e^{t}^{₀}, where α=e^{c} is a constant that indicates the scale of the surface.

In embodiments that use an orthographic-camera model, the additive integration constant manifests itself as an unknown translation in space along the camera axis. In embodiments that use a perspective-camera model, the constant α appears, through exponentiation, as an unknown multiplicative constant.

Accordingly, for each pixel in the images in the first set of images 212A that depicts a part of the surface of the object, the first unscaled surface coordinates 233A may represent that part of the surface with corresponding coordinates (ξ·z/f,η·z/f,z), where z=e^{t}^{₀}, and which assumes α=1. Collectively, the first unscaled surface coordinates 233A define an integrated surface.

After block B210, the first flow proceeds to block B215, where scale-factor calculation is performed based on the first unscaled surface coordinates 233A and on the first LMD-pixel indices 231A. This scale-factor calculation produces the first scale factor 234A. In order to calculate the first scale factor 234A, some embodiments of the measurement device triangulate points to fit the integrated surface that is defined by the first unscaled surface coordinates 233A. However, these triangulation points may have large errors and may produce unpredictable results for the scale factor due to the size of the LMD pixels. Because the image-capturing device's pixel size may be much smaller than the LMD pixel sizes, some embodiments of the measurement device estimate the scale factor by back-tracing the rays from the image-capturing device to the LMDs and determining the scale factor using a maximum likelihood technique.

For example, some embodiments of the measurement device recompute the first normal field of the surface based on the first unscaled surface coordinates 233A. Then these embodiments may use backward ray tracing to determine the scale factor by testing several candidate scale factors (e.g., the scale factors in a particular range of scale factors). For each candidate scale factor, the measurement device traces rays from the image-capturing device's pixels in the reflection regions (i.e., the parts of the image that depict a specular reflection from the surface of the object), computes the back-reflected rays that intersect with the two light-modulating devices, and computes the LMD-pixel indices of the back-reflected rays. The measurement device then computes the differences between the first LMD-pixel indices 231A and the back-reflected LMD-pixel indices for the candidate scale factor. To determine the scale factor α (e.g., the first scale factor 234A), the measurement device may select the candidate scale factor that has the smallest differences.

Due to the noise in light transport, the back-reflected LMD-pixel indices may be subject to errors that are related to the object's geometry and the distance between the light-modulating devices (e.g., the back light-modulating device may have larger errors than the front light-modulating device). Therefore, the measurement device may use the inverse of the standard deviations of the LMD-pixel indices in a small neighborhood as weights for balancing the index errors.

In some embodiments, the calculation of a scale factor α can be described by the following objective function:

$${α}^{*} = arg {min}_{α} {\sum }_{i ∈ R} ( {( \frac{{\hat{u}}_{i} - {u}_{i} ( α )}{{σ}_{i , f}^{x}} )}^{2} + {( \frac{{\hat{v}}_{i} - {v}_{i} ( α )}{{σ}_{i , f}^{y}} )}^{2} + {( \frac{{\hat{s}}_{i} - {s}_{i} ( α )}{{σ}_{i , b}^{x}} )}^{2} + {( \frac{{\hat{t}}_{i} - {t}_{i} ( α )}{{σ}_{i , b}^{y}} )}^{2} ) , \qquad ( 4 )$$

where i is the image-capturing-device-pixel index in the reflection region R; where (ûᵢ, \hat{v}ᵢ) and (ŝᵢ, \hat{t}ᵢ) are, respectively, the measured LMD-pixel indices (e.g., the first LMD-pixel indices 231A) for the front and back light-modulating devices; where (uᵢ(α), vᵢ(α)) and (sᵢ(α), tᵢ(α)) are, respectively, the back-reflected LMD-pixel indices on the front and back light-modulating devices for the scale factor σ; and where σ_{i,f}^{x}, σ_{i,f}^{y}, σ_{i,b}^{x}, and σ_{i,b}^{y} are, respectively, the standard deviations at pixel i for horizontal and vertical LMD-pixel index maps of the front and back light-modulating devices. The scale factor α can be calculated by minimizing the objective function.

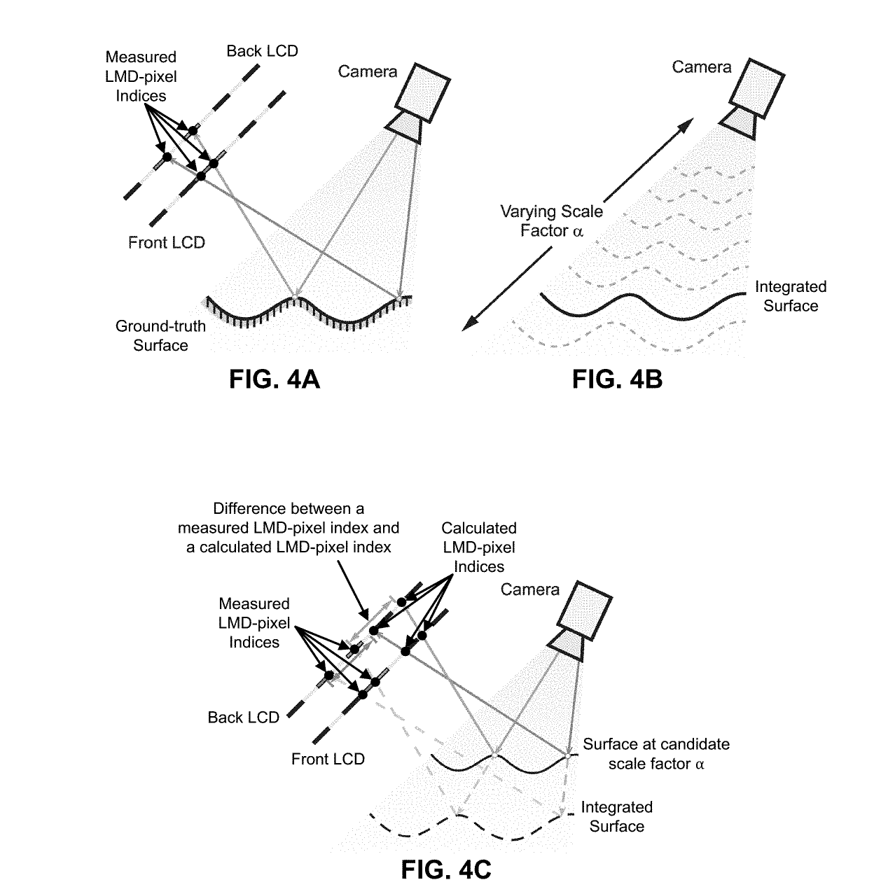

For example, FIGS. 4A-4C illustrate example embodiments of measured LMD-pixel indices, integrated surfaces, and calculated LMD-pixel indices. FIG. 4A is a conceptual illustration of back-tracing light rays from an image-capturing device, which is a camera in this example. The path that a light ray travels from the light-modulating devices (which are LCDs in FIG. 4A) to the camera depends on the light ray's LMD-pixel indices and on the ground-truth surface. Once the camera captures the light ray, the image can be decoded to determine the light ray's measured LMD-pixel indices. When the positions and orientations of the camera and the light-modulating devices are known, the direction of the light ray from the camera to the ground-truth surface can be determined from the image, and the direction of the light ray from the light-modulating devices to the ground-truth surface can be determined from the measured LMD-pixel indices. And when these directions of the light ray are known, the coordinates of the point on the ground-truth surface that reflected the light ray can be determined. Additionally, when the paths of multiple light rays in an image are known, the shape of the ground-truth surface can be determined.

FIG. 4B is a conceptual illustration of varying the scale factor α. Conceptually, varying the scale factor α allows a measurement device to compare different candidate surfaces with an integrated surface.

FIG. 4C illustrates an example of a comparison of a surface at a candidate scale factor α to an integrated surface. Because the image-capturing device's pixel size may be much smaller than the LMD pixel size, some embodiments of a measurement system estimate the scale factor by back-tracing the rays from the image-capturing device to the light-modulating devices. To accomplish this, the surface is scaled according to the candidate scale factor α, then the light rays are back traced from the camera to the scaled surface and then to the light-modulating devices. Then the respective LMD-pixel indices of the light rays are calculated. The differences between the calculated LMD-pixel indices and the measured LMD-pixel indices are then calculated.

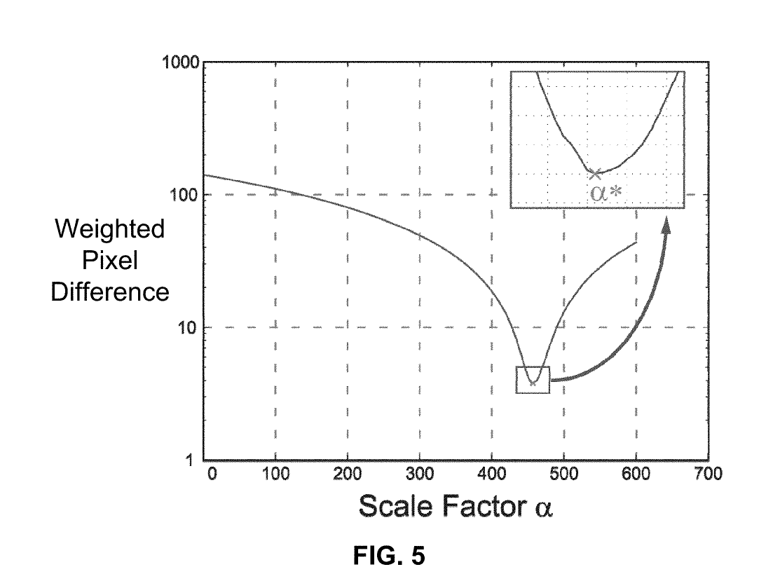

FIG. 5 illustrates an example embodiment of the relationship between weighted pixel differences and different scale factors for an objective function (e.g., the objection function in equation (4)). Some embodiments of the measurement device select the scale factor α that has the lowest weighted pixel difference (e.g., in blocks B215 and B216).

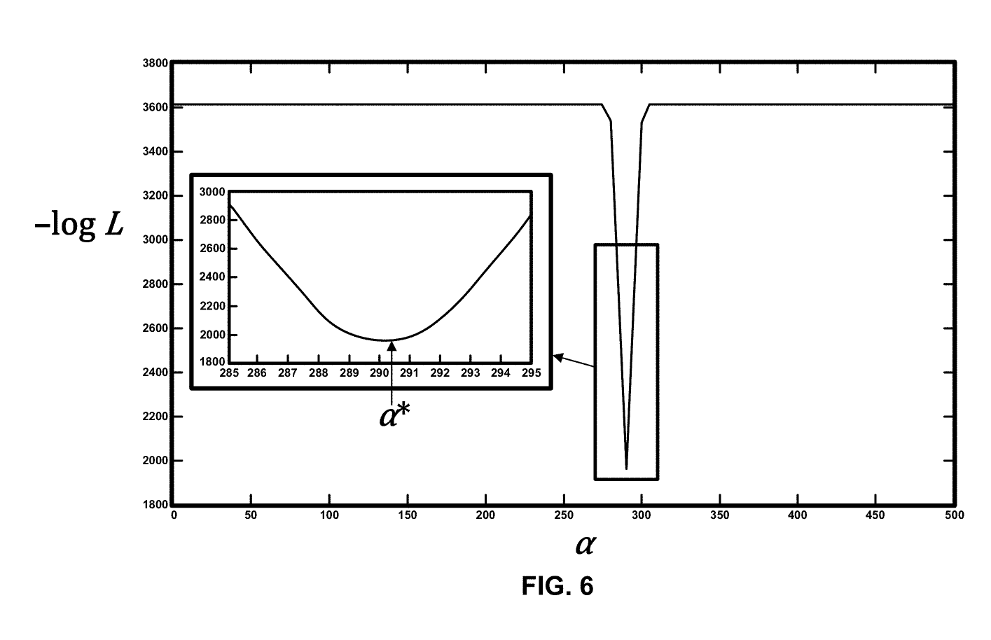

Also, to avoid local minimums, some embodiments of the measurement device search through a large range of scale factors. Because the objective function may be flat over much of its range, some embodiments conduct a multi-resolution search: they search using larger steps in the flat region and search using finer steps around the peak. FIG. 6 illustrates an example embodiment of the relationships between the outputs of an objective function and different scale factors. The objective function is flat over most of its range, but the objective function does include a peak. Accordingly, to find α*, some embodiments of the measurement device search using larger steps in the flat parts of the range and search using finer steps near the peak.

Referring again to FIG. 2, after block B215 the first flow proceeds to block B220, where first scaled surface coordinates 235A are calculated based on the first unscaled surface coordinates 233A and the first scale factor 234A. The first flow then moves to block B225, where it merges with the second operational flow (“second flow”).

The second flow begins in block B201, where the measurement device obtains a second set of images 212B of the object, and the measurement device decodes the second set of images 212B, thereby generating second LMD-pixel indices 231B.

Next, in block B206, the measurement device performs ray triangulation based on the second LMD-pixel indices 231B to generate a second normal field 232B for the object, as the object is shown in the viewpoint of the second set of images 212B. The second flow then moves to block B211, where the measurement device performs normal-field integration on the second normal field 232B to generate second unscaled surface coordinates 233B. Then the second flow proceeds to block B216, where scale-factor calculation is performed based on the second unscaled surface coordinates 233B and on the second LMD-pixel indices 231B. This scale-factor calculation produces the second scale factor 234B. The second flow then moves to block B221, where coordinate calculation is performed, thereby producing the second scaled surface coordinates 235B. The second flow then moves to block B225, where it merges with the first flow.

In block B225, multi-view scale-factor optimization is performed based on the first scaled surface coordinates 235A, on the second scaled surface coordinates 235B, on a first transformation matrix 209A, and on a second transformation matrix 209B. The first transformation matrix 209A and the second transformation matrix 209B may have been previously stored by the measurement device, for example during a calibration procedure. Each transformation matrix can describe the translation and the rotation from the image-capturing device to a respective pose of the object.

If the first set of images 212A and the second set of images 212B each has a different viewpoint of the object (e.g., the object was rotated between image captures), then respectively applying the first scale factor 234A and the second scale factor 234B to the first scaled surface coordinates 235A and the second scaled surface coordinates 235B produces a disjoint union of scaled object surfaces. A scaled object surface may be described in the image-capturing device's coordinate system according to {α_{Ω}⁽⁰⁾W_{Ω}}, where α_{Ω}⁽⁰⁾ is a scale factor and where W_{Ω} is a window that has a respective viewpoint of the surface (for example as described in FIG. 11A).

To account for different viewpoints, some embodiments of the measurement device transform the scaled object surfaces into a common coordinate system, which may be referred to herein as a world coordinate system. For example, even if only one image-capturing device is used to capture the first set of images 212A and the second set of images 212B, the object may have been rotated between image captures. Thus, the relationship of the object's coordinate system to the image-capturing device's coordinate system will be different in the two images. By applying the rotation and the translation described by the first transformation matrix 209A to the first scaled surface coordinates 235A, and by applying the rotation and the translation described by the second transformation matrix 209B to the second scaled surface coordinates 235B, the measurement device can produce a disjoint union of scaled object surfaces in the world coordinate system. A scaled object surface in the world coordinate system may be described as follows: {R⁻¹(α_{Ω}⁽⁰⁾W_{Ω}T)}, where R is a rotation matrix, where T is a translation matrix, and where the combination of R and T is a transformation matrix.

Then, in multi-view fitting, the measurement device combines the different viewpoints of the scaled object surfaces by minimizing the differences between the scaled object surfaces where the scaled object surfaces overlap. The measurement device may measure the differences in both position and angle. Some embodiments of the measurement device combine the different viewpoints as described by the following objective function, which matches a surface co from view i and a surface ω′ from view j:

Σ(α_{ω},α_{ω′})=d_{C}_{⁰}(Rᵢ⁻¹(α_{ω}W_{ω}−Tᵢ),Rⱼ⁻¹(α_{ω′}W_{ω′}−Tⱼ))+d_{C}_{¹}(Rᵢ⁻¹(α_{ω}W_{ω}−Tᵢ),Rⱼ⁻¹(α_{ω′}W_{ω′}−Tⱼ))), (5)

where d_{C}_{⁰} measures topological closeness between the two surfaces (e.g., in mm), where d_{C}_{¹} measures closeness in the tangent space of the two surfaces (e.g., in degrees), where W is a window of an unscaled surface, where R is a rotation matrix, where T is a translation matrix, where the combination of R and T is a transformation matrix, and where α is a scale factor.

If the initial scale factors (e.g., the first scale factor 234A and the second scale factor 234B) from the single views have large errors, then the multi-view fitting may converge very slowly. Some embodiments of the measurement device increase the speed of the multi-view fitting by considering additional surface constraints (e.g., curvature).

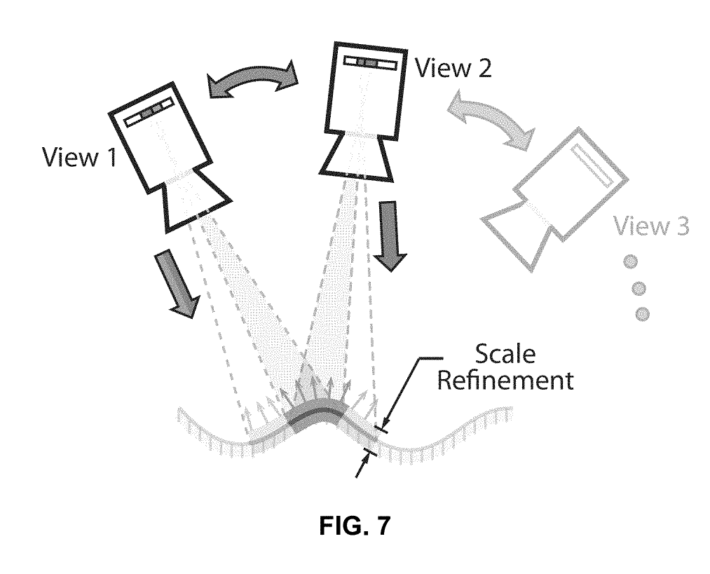

FIG. 7 is a conceptual illustration of an example embodiment of multi-view scale refinement. In FIG. 7, the surfaces from view 1 and view 2 are used to refine the respective scale factors in the indicated range. Thus, even though the surfaces are within the indicated range (which may be very small), the refinement of the scale factors moves the surfaces closer together.

The multi-view scale-factor optimization in block B225 produces a first refined scale factor 236A and a second refined scale factor 236B. The first refined scale factor 236A and the second refined scale factor 236B may be different from each other. The flow then moves to block B230, where first refined surface coordinates 237A are calculated based on the first refined scale factor 236A and on the first unscaled surface coordinates 233A, and where second refined surface coordinates 237B are calculated based on the second refined scale factor 236B and on the second unscaled surface coordinates 233B.

Finally, the flow moves to block B235, where the first refined surface coordinates 237A and the second refined surface coordinates 237B are transformed to a common coordinate system (e.g., the world coordinate system) based on the first transformation matrix 209A and the second transformation matrix 209B, respectively, and then the transformed and refined surface coordinates are merged to generate merged surface coordinates 238, which are a representation of the shape of the surface (e.g., a point cloud that describes the shape of the surface), and which define an integrated surface. Because the merged surface coordinates 238 were generated from the first refined surface coordinates 237A and the second refined surface coordinates 237B, the merged surface coordinates 238 that are produced by block B235 may also be referred to herein as refined merged surface coordinates.

FIG. 8 illustrates an example embodiment of an operational flow for decoding captured images of an object. The flow starts in block B800, where a measurement device obtains a set of images of an object that was captured by an image-capturing device in a system for measuring the shapes of objects. The flow then moves to block B805, where the measurement device then performs blocks B810 and B815 for each light-modulating device (LMD) in the system. In block B810, the measurement device decodes the horizontal pattern and the vertical pattern of the light-modulating device in the images in the set of images. In block B815, the measurement device recovers the LMD-pixel indices for the light-modulating device based on the horizontal patterns and the vertical patterns. In this example embodiment, the measurement device represents the LMD-pixel indices with a horizontal index map and a vertical index map, for example as shown in FIG. 9B.

The flow then moves to block B820, where the measurement device generates a combined index map based on the horizontal index maps and the vertical index maps. However, if a pixel in the image of the object does not capture an LMD signal (i.e., capture light that was both transmitted by the LMDs and reflected by the object), then the index map will show noise at this pixel of the image. Consequently, the combined index map may include noise in addition to the horizontal and vertical LMD-pixel indices of the LMD pixels that transmitted the light that was reflected by the object and that was captured in the image. But an image pixel that does not have an LMD signal is typically surrounded by image pixels that have invalid LMD-pixel indices, even if the image pixel that does not have an LMD signal has a valid LMD-pixel index. An example of an invalid LMD-pixel index is an index that is larger than the physical pixel resolution of the LMD. For example, for an LMD that has a pixel resolution of 1920×1080, a valid horizontal index must lie between 1 and 1920, and a valid vertical index must lie between 1 and 1080. Also, when the LMD-pixel indices are encoded by 11 bit binary code, which has a nominal range of 1 to 2048, a pixel with no LMD signal may tend to take a random value between 1 and 2048, and would therefore appear as noise.

FIG. 9A illustrates an example embodiment of an image of an object, and FIG. 9B illustrates example embodiments of index maps of the image of the object in FIG. 9A. FIG. 9A shows an image of a specular object that was captured by a system that included two LMDs. The image includes image pixels that have an LMD signal and includes image pixels that do not have an LMD signal. Some of the image pixels that have an LMD signal are roughly included in four LMD-signal areas 901.

FIG. 9B includes four index maps, two per LMD. For each LMD, one of the two index maps is a horizontal index map and the other is a vertical index map. The indices at the image pixels that have an LMD signal, many of which are included in the four LMD-signal areas 901, appear to be valid indices, and the indices at the image pixels that do not have an LMD signal appear to be noise.

After generating the combined index map in block B820, the flow moves to block B825 where, to exclude image pixels that show noise, the measurement device generates one or more image masks. Some embodiments of the measurement device generate a mask M₀ that defines image-pixel regions and that can be described according to the following:

M₀=v(I_{x,B})&v(I_{y,B})&v(I_{x,F})&v(I_{y,F}), (6)

where I_{x,B}, I_{y,B}, I_{x,F}, and I_{y,F} are index maps, where v(I) denotes the mask containing only the image pixels in index map 1 that have valid index values, and where & is the pixel-wise AND operator. However, this mask M₀ may remove only nominally invalid image pixels, and the resulting image-pixel regions may still be noisy. Thus, to smooth out the image-pixel regions, some embodiments of the measurement device generate a mask M₁ for defining image-pixel regions that can be described according to the following:

M₁=M₀&(k_{w}*M₀>τ), (7)

where k_{w} is a box convolution kernel of size w×w (e.g., w=51), such as a constant w×w matrix with the value 1/w², and where τ is a threshold value (e.g., τ=0.8).

Additionally, some embodiments of the measurement device also require the image pixels to receive only a direct reflection from the surface, as opposed to a secondary reflection, or interreflection. In some of these embodiments, the image mask M₂ can be described as follows:

M₂=M₁& M_{x,B}& M_{x,F}& M_{y,B}& M_{y,F}, (8)

where
M_{x,B}=(k_{w}*(∇ₓI_{x,B}<0)>τ_{d}),
M_{x,F}=(k_{w}*(∇ₓI_{x,F}<0)>τ_{d}),
M_{y,B}=(k_{w}*(∇_{y}I_{y,B}>0)>τ_{d}), and
M_{y,F}=(k_{w}*(∇_{y}I_{y,F}>0)>τ_{d})
   are auxiliary masks; where ∇ₓ and ∇_{y} are derivative operators; where k_{w} is a box convolution kernel of size w×w; and where τ_{d} is a threshold value (e.g., τ_{d}=0.65).

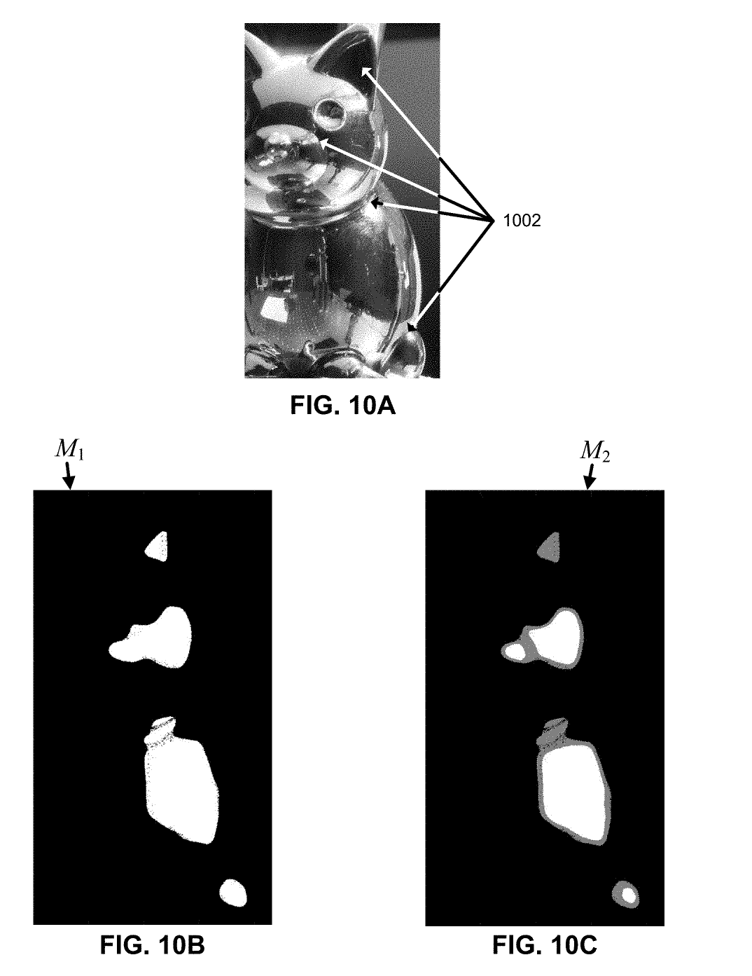

FIG. 10A illustrates an example embodiment of an image of an object, and FIGS. 10B-10C illustrate example embodiments of image masks. The surface of the object has sites of potential secondary reflections 1002. FIG. 10B illustrates an image mask M₁ that was generated according to equation (7). FIG. 10C illustrates an image mask M₂ that was generated according to equation (8). Thus, the image mask M₂ in FIG. 10C eliminates image pixels that capture secondary reflections. The image pixels that capture secondary reflections are shaded to allow easy comparison with the image mask M₁ in FIG. 10B.

Finally, after generating the one or more image masks in block B825, in block B830 the measurement device generates LMD-pixel indices based on the one or more image masks and on the combined index maps. For example, the LMD-pixel indices may be the indices in the combined index map that are not removed by the one or more masks, and the LMD-pixel indices may be represented by an index map. The LMD-pixel indices may not include indices for most or all of the image pixels that did not capture an LMD signal. Accordingly, the LMD-pixel indices may include indices only for the image pixels that captured a direct LMD signal. Also, the LMD-pixel indices may include indices only for the image pixels that captured either an indirect LMD signal or a direct LMD signal. And some embodiments of the measurement device remove the LMD-pixel indices for small islands of image pixels that have a valid LMD signal, for example all contiguous areas that have less than 2,000 image pixels.

FIG. 11A illustrates an example embodiment of a window. The window W has a respective viewpoint of the object. In this embodiment, the window W includes only a subset of the entire image 1112. However, in other embodiments, a window W includes the entire image 1112. Some embodiments of the measurement device divide an image 1112 into windows that are smaller than the entire image 1112 to reduce computational complexity. For example, if the number of pixels exceeds 500,000, some embodiments of a measurement system divide the pixels into windows and integrate each window separately. This may make each sub-problem more computationally tractable and allow the computation to scale to larger images.

The image 1112 shows captured reflections from the object, and the captured reflections may be shown in a set of disjoint pixel regions that captured a valid LMD signal, as shown in FIG. 11A. These disjoint pixel regions further intersect with the window W to form n_{W} disjoint pixel regions M_{W} within the window W, for example as described by the following:

$${M}_{W} = {∐}_{k = 1}^{{n}_{W}} {M}_{W , k} ⊆ W ⊆ {Z}^{2} , \qquad ( 9 )$$

where Z² is the binary space. Thus, in this example the generated mask M_{W} is binary and is a two-dimensional matrix.

Note that normal-field integration gives a non-unique function x_{W}=(x_{W}, y_{W},z_{W}): M_{W}→R³, where R³ is the domain of real numbers, which is defined up to n_{W} arbitrary multiplicative constants α_{1,w}, . . . , αₙ_{_{w}}_{,w}, each of which corresponds to a disjoint pixel region of the window W. If α_{W}=(α_{1,w}, . . . , αₙ_{_{w}}_{,w}), and if region-wise multiplication could be described as (α_{W} [symbol] x_{W})|_{M}_{_{w,k}}=α_{k,w}·x_{W}|_{M}_{_{w,k}}, then determining these constants, or scale factors, could be used to produce a depth map in the local coordinate system of the image-capturing device.

The window W has a viewpoint, which is the viewpoint of the image-capturing device that captured the image 1112. This is the basis for two mappings. The first mapping is a transformation T_{W}: R³→R³ from a world coordinate system to the image-capturing device's coordinate system, which may be described by extrinsic parameters of the image-capturing device. In some embodiments, the transformation T_{W} can be described as follows: T_{W}p=R_{W}p+t_{W}, where pεR³, where R_{W}εSO (3) is a rotation matrix, and where t_{W}εR³ is a translation matrix. The world coordinate system may be considered to be oriented to the object and can be defined by fiducial markers (e.g., a checkerboard) that are attached to the object.

The second mapping is a projection from the world coordinate system to the pixel space of the image-capturing device. In some embodiments, the second mapping can be described by P_{W}: R³→Z². In addition to the extrinsic parameters of the image-capturing device, this projection also depends on the intrinsic parameters of the image-capturing device.

Using the aforementioned notation, the multi-view optimization operation (e.g., the operation in block B225 in FIG. 2) can be described as follows: given a set of windows Ω,

$$\begin{matrix}{\{ {α}_{W}^{*} \}}_{W ∈ Ω} = {argmin}_{{\{ {α}_{W} \}}_{W ∈ Ω}} \frac{1}{N} {\sum }_{W \neq {W}^{′}} {\sum }_{q ∈ {M}_{W} ⋂ {φ}_{{α}_{W} , W , {W}^{′}}^{- 1} ( {M}_{{W}^{′}} )} {ɛ}_{W , {W}^{′}} ( q ; {α}_{W} , {α}_{{W}^{′}} ) , \\ where & ( 10 ) \\ {ɛ}_{W , {W}^{′}} ( q ; {α}_{W} , {α}_{{W}^{′}} ) = {‖ {T}_{{W}^{′}}^{- 1} ∘ ( {α}_{{W}^{′}} ⊗ {x}_{{W}^{′}} ) ( {Φ}_{{α}_{W} , W , {W}^{′}} ( q ) ) - {T}_{{W}^{′}}^{- 1} ∘ ( {α}_{W} ⊗ {x}_{W} ) ( q ) ‖}^{2} , \\ where & ( 11 ) \\ {Φ}_{{α}_{W} , W , {W}^{′}} = {P}_{{W}^{′}} ∘ {T}_{W}^{- 1} ∘ ( {α}_{W} ⊗ {x}_{W} ) , & ( 12 )\end{matrix}$$

and where N is the total number of summands. For a given set of scale factors {α_{W}}_{WΣΩ}, the function ε_{W,W′} (q; α_{W}, α_{W′}) measures a discrepancy between the integrated surfaces (e.g., point clouds of surface coordinates) for windows W and W′ along the viewpoint of W′ for pixel q in W. The discrepancy can be computed in the overlap of the surfaces in the positions of the surfaces.

For example, FIG. 11B is a conceptual illustration of an example embodiment of multi-view scale refinement with an objective function. As illustrated by FIG. 11B, the overlap can be determined using the viewpoint of window W as a reference. Also, pixel q, where qεM_{W}, is within the mask of W. For a current value of α_{W}, the three-dimensional coordinates of pixel q in the world coordinate system can be calculated according to T_{W}⁻¹◯(α_{W} [symbol] x_{W})(q), and the coordinates of the corresponding pixel of pixel p in window W′ can be calculated according to p=P_{W′}◯T_{W}⁻¹◯(α_{W} [symbol] x_{W})(q)=Φ_{α}_{_{W}}_{,W,W′}(q), which is required to lie inside M_{W′}. Also, some embodiments of the measurement device use the corresponding mask of M_{W′} in window W, which is Φ_{α}_{_{W}}_{,W,W′}⁻¹(M_{W′}), and compute the discrepancy ε_{W,W′}(q; α_{W}, α_{W′}) for pixel q wherever qεM_{W}∩Φ_{α}_{_{W}}_{,W,W′}⁻¹(M_{W′}).

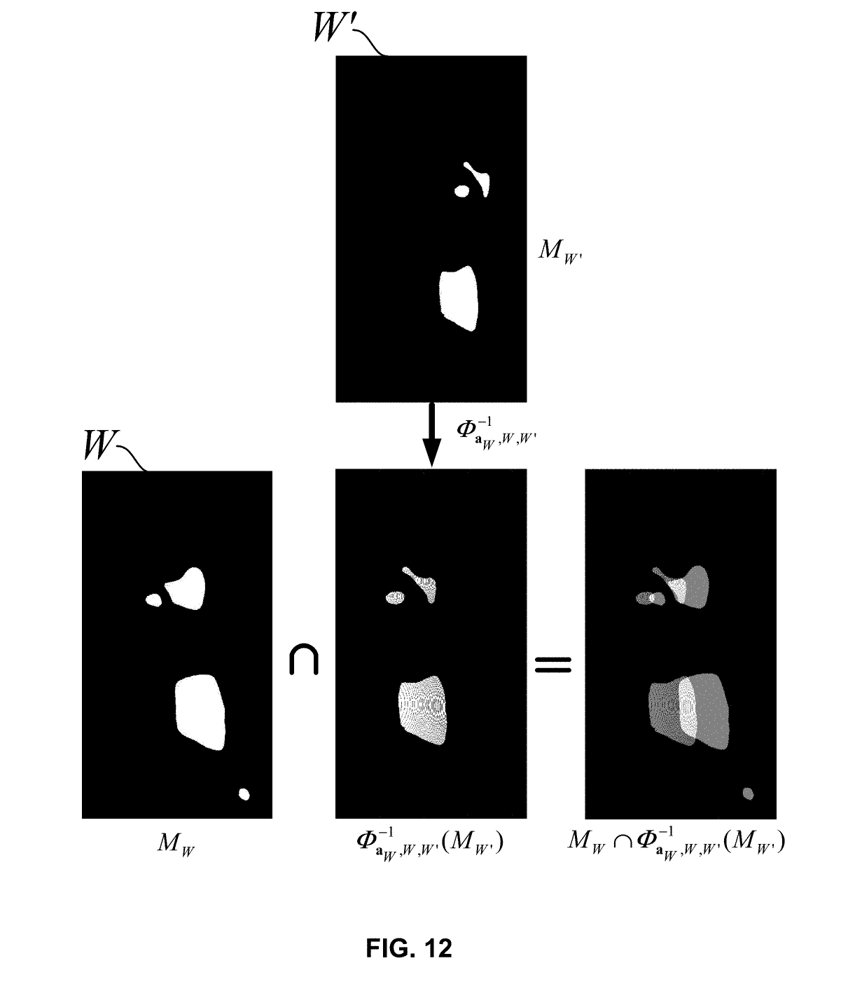

FIG. 12 illustrates an example embodiment of overlapped regions between two windows, as shown by their respective masks. One window W has mask M_{W}, and the other window W′ has mask M_{W′}. Note that, in this example, the corresponding mask Φ_{α}_{_{W}}_{,W,W′}⁻¹(M_{W′}) of mask M_{W′}in the coordinates of window W has gaps or holes because of the resolution conversion from one viewpoint to the other. The view of the intersection of mask M_{W} and mask Φ_{α}_{_{W}}_{,W,W′}⁻¹(M_{W′}) shows where the points on the surface of the object overlap (i.e., the same point on the surface is shown in both window W and window W′). In the view of the intersection of mask M_{W} and mask Φ_{α}_{_{W}}_{W,W′}⁻¹(M_{W′}), the intersection is shown in the lightest shade, the remainder of mask M_{W} and mask Φ_{α}_{_{W}}_{,W,W′}⁻¹(M_{W′}) are shown in a darker shade, and the rest of the view is shown in black.

When solving the objective function as described in equation (5) and equation (10), the measurement device may perform computations for every combination of W≠W′. Some embodiments of the measurement device use the scale factors α that were obtained by fitting the integrated surfaces to triangulated points (e.g., as performed in blocks B215 and B216) as the initial values of {α_{W}}_{WεΩ}. Also, some embodiments of the measurement device start with one or more randomly-chosen scale factors α. These embodiments may restart with other randomly-chosen scale factors α if the solving of the objective function gets stuck at a bad local minimum.

Some embodiments of the measurement device solve the objective function using an optimization algorithm that does not require derivatives of the objective function, and some embodiments of the measurement device use an optimization algorithm that implements a simplex method or a Nelder-Mead algorithm.

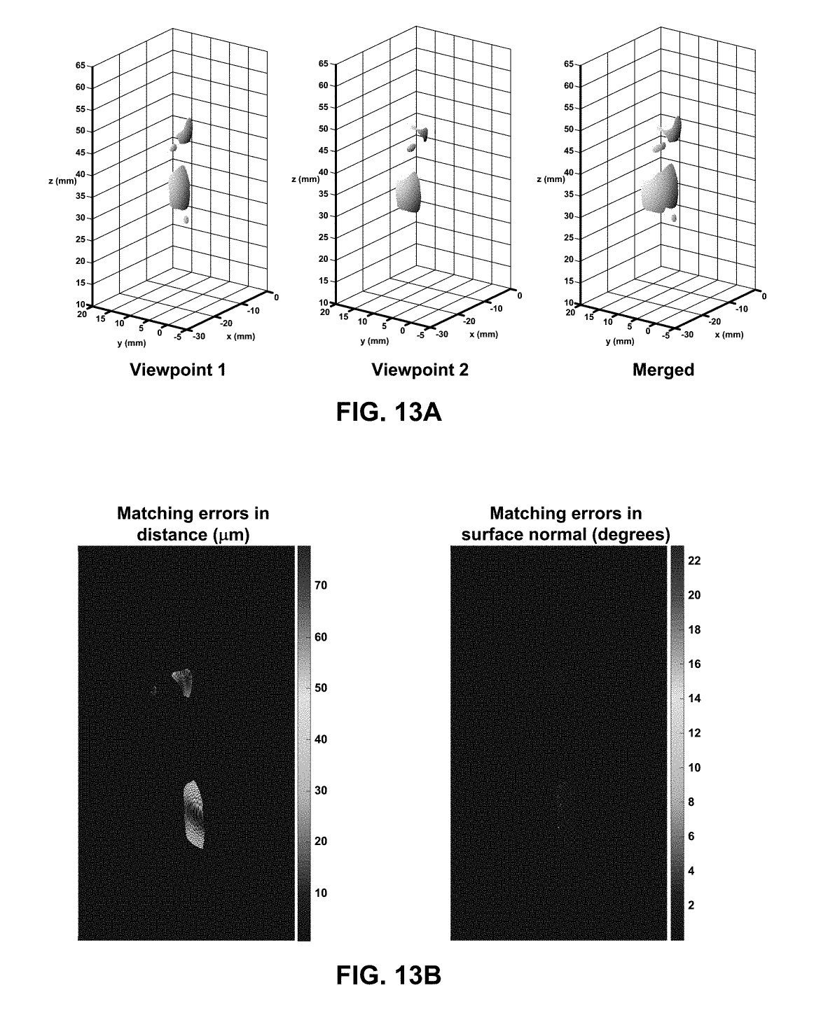

FIG. 13A illustrates example embodiments of refined surface coordinates and merged surface coordinates. FIG. 13A shows the respective refined surface coordinates for two viewpoints and shows the merged surface coordinates as Lambertian surfaces.

FIG. 13B shows the errors in distance and surface normals in the overlap of the surface coordinates of FIG. 13A. FIG. 13B shows the distance errors in micrometers and the normal-vector errors in degrees. The mean distance error is 23.3 μm. The mean normal-vector error is 1.07°.

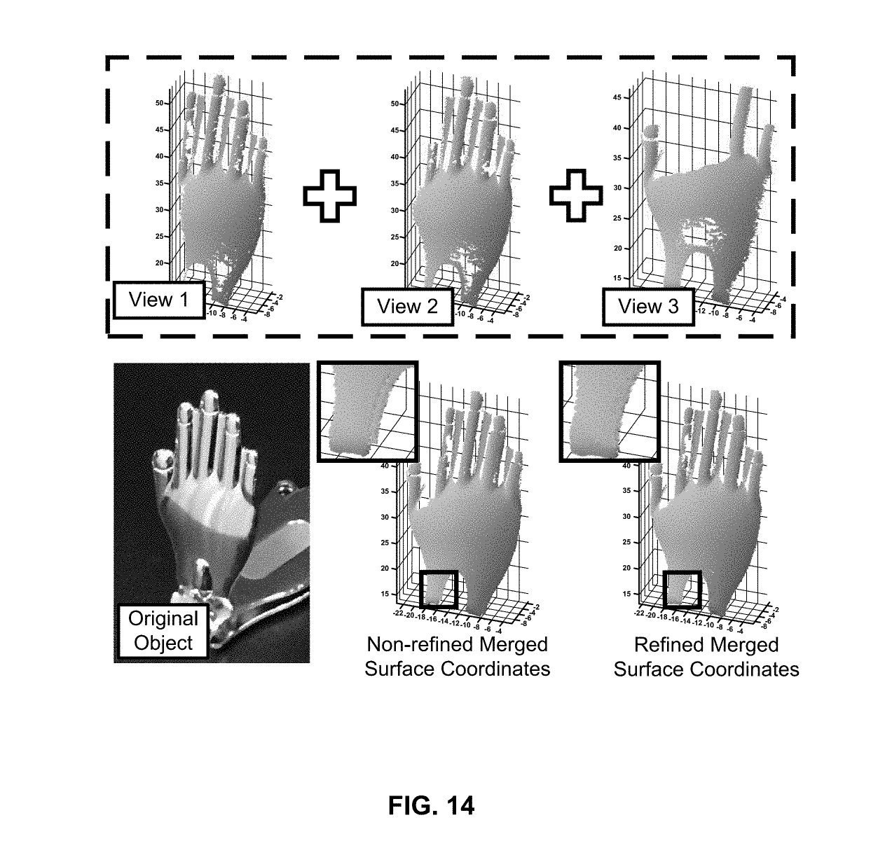

FIG. 14 illustrates example embodiments of an object, the surface coordinates from different views of the object, and merged surface coordinates. The original object is shown in the lower-left, and the respective scaled surface coordinates of three different views are shown in the top row. The bottom-middle shows non-refined merged surface coordinates, which are generated by merging the scaled surface coordinates without jointly optimizing the scale factors (e.g., without performing blocks B225 and B230 in FIG. 2). The non-refined merged surface coordinates have artifacts (e.g., noticeable offsets between the different views). The bottom-right shows refined merged surface coordinates, which were generated by jointly optimizing the scale factors (e.g., by performing block B225 and B230 in FIG. 2).

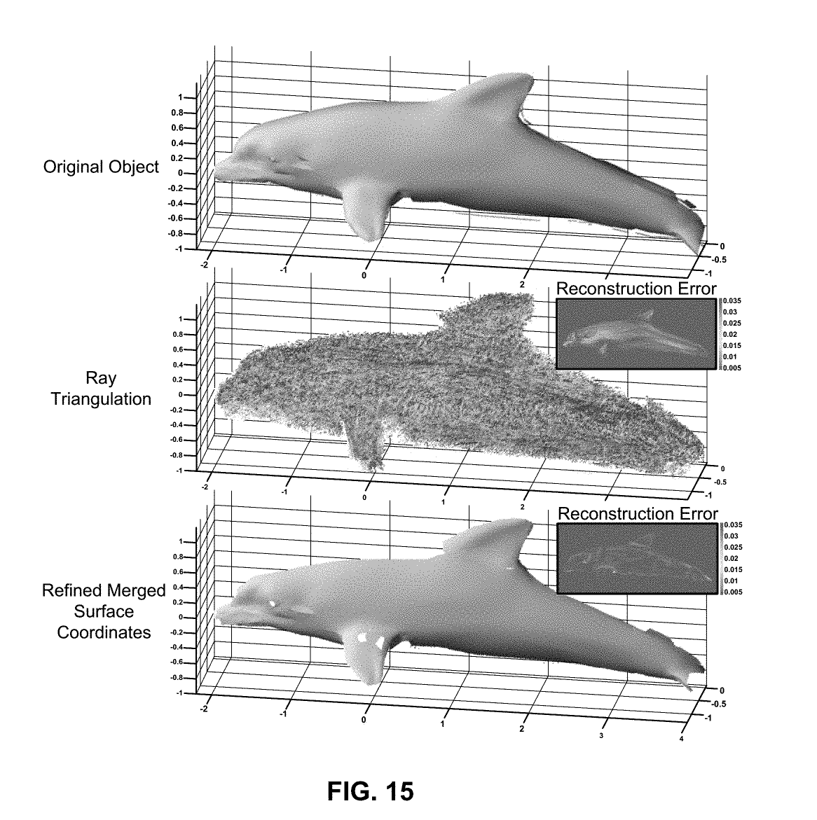

FIG. 15 illustrates example embodiments of an object model and refined merged surface coordinates. The object model and the measurement system were both implemented in a simulator. The object model was composed of synthetic data and is shown on top. The simulated measurement system that was used to generate the merged surface coordinates included two LMDs, each with a resolution of 1920×1080 pixels. The LMD size was 38.4×21.6 inches, and the LMD-pixel size was 0.02 mm. The object model was positioned 5.2 inches in front of the LMD that was closest to the object model. The simulated measurement system then rendered the reflection image using Pov-ray. To acquire complete coverage of the object, the simulated measurement system rotated the camera at +30° steps and combined the multiple viewpoints using joint optimization of the scale factor. The refined merged surface coordinates (which are in the form of a point cloud and which define an integrated surface) are shown on the bottom. The middle view shows surface coordinates (which are in the form of a point cloud) that were generated by using only direct ray triangulation. Due to the large LMD-pixel size, these surface coordinates are very noisy.

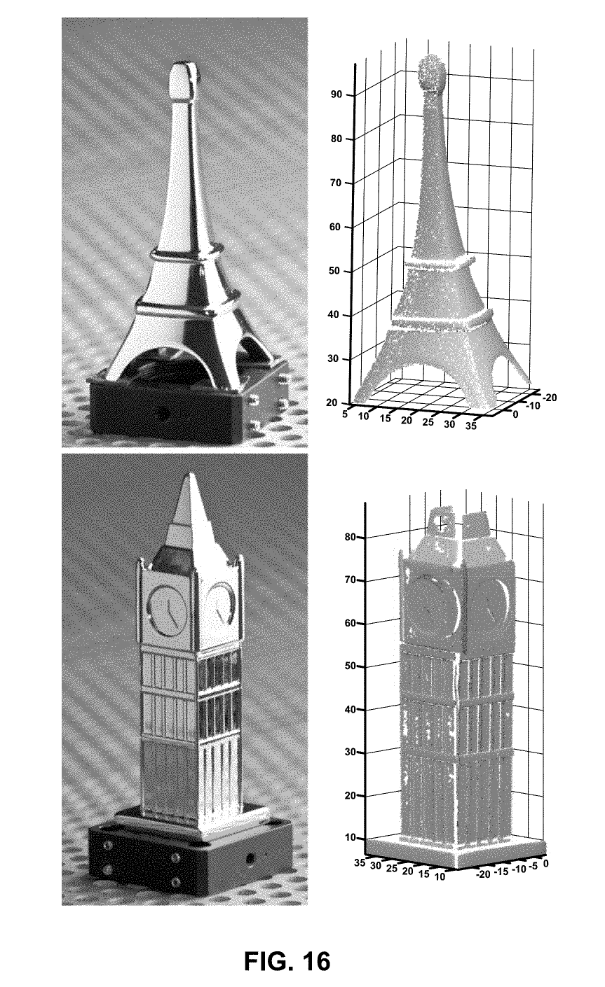

FIG. 16 illustrates example embodiments of objects and refined merged surface coordinates. The embodiment of the measurement system that was used to generate the refined merged surface coordinates included two LMDs, which were the LCD panels from two 15.6 inch displays. Each LMD had a resolution of 1920×1080 pixels, and the pixel size was 0.179 mm. The distance between the two LMDs was 30 mm. Note that a larger distance may increase the measurement accuracy, but it may reduce the angular-ray resolution. The objects were placed on a rotating stage to acquire complete coverage of their surfaces.

The image-capturing device was a DSLR camera, and the image-capturing device was positioned at the right side of the LMDs to capture the reflections of the LMDs from the object. The image-capturing device was calibrated using the Matlab calibration toolbox.

However, the LMDs were not directly visible to the image-capturing device. To calibrate the LMDs, an auxiliary image-capturing device that viewed the LMDs was used. First, the LMD positions relative to the auxiliary image-capturing device were calibrated. Then the viewing image-capturing device and the auxiliary image-capturing device were calibrated using a common checkerboard that was visible to both. The LMD positions were finally transformed into the viewing image-capturing device's coordinate system.

The objects were specular objects, and the objects were placed approximately 20 mm in front of the closest LMD. The measurement system pre-determined a bounding volume and generated an optimal code, and the measurement system rotated the objects with 20° steps to view their full surfaces. By decoding the images captured by the viewing image-capturing device, the measurement system obtained the LMD-pixel indices and established correspondences between illumination light rays from the LMDs and reflection light rays that were captured by the image-capturing device. Using ray intersection, the measurement system determined the surface normal and the coordinates of each intersection point. The measurement system estimated the single-view scale factors using the single viewpoints (e.g., as performed in blocks B215 and B216 in FIG. 2). The measurement system then used the single-view scale factors as initial values for multi-view scale-factor optimization and further refined the surface coordinates (e.g., as performed in blocks B225 and B230 in FIG. 2). To estimate the world transformation for each viewpoint, a 3×3 checkerboard was attached to the objects and used to calibrate their extrinsic parameters. After the multi-view scale-factor optimization, the measurement system used the iterative closest point (ICP) algorithm to update the transformation matrix to compensate for any calibration errors. And then the measurement system iteratively updated the transformation matrices (R, T) and the scale factors α until convergence was achieved. Finally, the measurement system generated the refined merged surface coordinates (e.g., as performed in block B235 in FIG. 2).

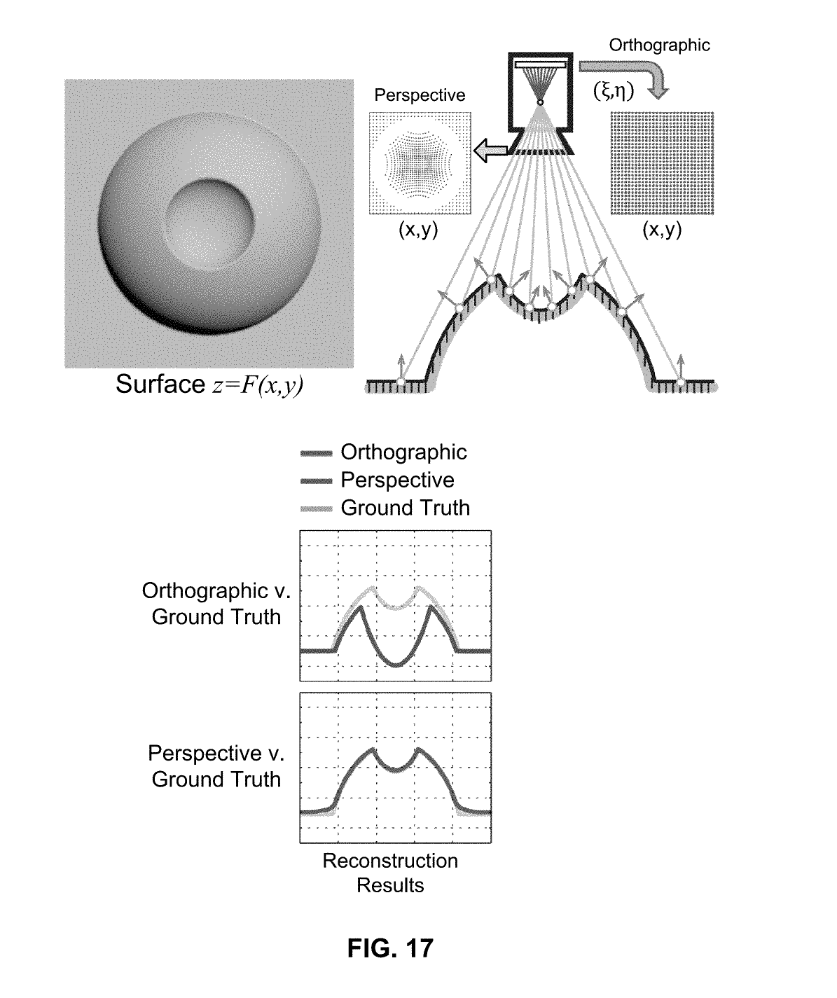

FIG. 17 illustrates example embodiments of a surface, a reconstruction of the surface that was generated using an orthographic-camera model, and a reconstruction of the surface that was generated using a perspective-camera model. Perspective-camera projection produces non-uniform samples in the coordinates (x, y) of the world coordinate system on the image plane. The non-uniformity is shown by the unequal spacing between the points in the coordinates. However, orthographic-camera projection assumes uniform samples in the coordinates (x, y) of the world coordinate system on the image plane. In FIG. 17, the reconstruction of the surface z=F(x, y) that was generated using the perspective-camera model is more accurate than the reconstruction of the surface that was generated using an orthographic-camera model.

FIG. 18 illustrates example embodiments of light-modulating devices (LMDs) and a light source. The LMDs 1820A-B each include a respective liquid crystal display (LCD) 1821 and a respective polarizer 1822. In this embodiment, the polarization rotation of the two LMDs 1820A-B is configured such that the LMD-pixel operation between the two LMDs 1820A-B is linear in the binary space. Thus, the polarizer 1822 that is between the light source 1825 and the back LMD 1820A is a horizontal polarizer, and the other polarizer 1822 is a vertical polarizer. The two polarizers 1822 thereby form two perpendicular linear-polarization layers.

The LCDs 1821 use the polarization-modulation properties of liquid crystal to form images: a display image appears white where the light rays are twisted 90 degrees by the liquid crystal, otherwise the image appears black. Consider a light ray \vec{r}=[u, v, s, t] emitted from the unpolarized light source 1825. After passing through the first horizontal polarizer 1822, the light ray \vec{r} is horizontally polarized. In order to pass through the second vertical polarizer 1822 and become visible, the horizontally-polarized light ray \vec{r} needs to be twisted once by 90° by the two LCDs 1821. When the horizontally-polarized light ray \vec{r} is untwisted or twisted twice by 90° (e.g., polarization rotates the light ray \vec{r} by 180°), the light ray \vec{r} is blocked and not visible. This resembles the logical exclusive or (XOR) operator that outputs “true” only when both inputs differ. Thus the observed binary code Bᵣ(\vec{r}) for the light ray \vec{r} can be described by Bᵣ(\vec{r})=B_{f} (u, v)⊕B_{b}(s, t), where ⊕ is the XOR operator, and where B_{f} and B_{b} are the binary code patterns on the front and back LMDs, respectively. Because XOR is linear in the binary space (addition modulo 2), it enables code multiplexing onto the two LMDs using a projection matrix.

Some embodiments of a measurement system implement a minimum binary-code book for the light rays such that every light ray has a unique binary-code sequence. To encode the light rays, some embodiments use standard Gray code for each LMD. Assuming that each LMD has N pixels, the total number of light rays in the illumination light field is M_{fulllightfield}=0(N²). However, sometimes only a small subset of light rays can be reflected by the object and captured by an image-capturing device, as shown in FIG. 19. FIG. 19 illustrates example embodiments of light-modulating devices 1920A-B, an object 1930, an effective light field 1939, and a bounding volume 1941. The effective light field 1939 is the subset of light rays that are reflected by the object and captured by an image-capturing device or that intersect the bounding volume 1941.

Therefore, some embodiments of a measurement system encode only the light rays in the effective light field 1939, which may reduce acquisition time. If, for each pixel on the back LMD 1920A, only a cone of ˜k light rays will intersect the object 1930 or the bounding volume 1941, where k<<N, then the number of effective light rays is M_{effective}=k×N<<N².

Some embodiments of the measurement system first determine the effective light field (e.g., the bounding volume 1941) for the object 1930 and encode only the light rays in the effective light field. Also, some embodiments of the measurement system use an iterative adaptive approach to generate the binary-code pattern for the two LMDs.

To simplify the description of the encoding, assume that each LMD has the same pixel resolution N. Let the number of light rays be l, and let A denote an l×2N matrix. If the i-th light ray is uniquely identified by LMD-pixel coordinates on the two LMDs, denoted respectively by uᵢ and sᵢ, then in the i-th row of A,

A(i,uᵢ)=1 and

A(i,N+sᵢ)=1, (13)

and everywhere else is zero.

Given the composite binary-code sequence matrix X for the two LMDs, the resulting binary-code matrix R for the light rays in the effective light field can be described by the following:

R=AX, (14)

where the binary code sequence matrix X is a 2N×K binary matrix for the LMDs that indicates the K sets of binary-code patterns that are displayed on the LMDs, and where the binary-code matrix R is an l×K binary matrix of the ray codes. The linearity of the XOR operation enables this representation. Also, this formulation can be extended to the general case of m LMDs for any m≧2 and to LMDs that have different pixel resolutions.

Some embodiments of a measurement system determine the binary-code-sequence matrix X such that the resulting binary-code matrix R has unique row vectors (each light ray will receive a unique code vector). These embodiments may start from a known solution X₀ that has dimensions 2N×K₀ such that the resulting binary-code book R has unique rows. One example of a known solution is the Gray code X₀:

$${X}_{0} = [ \begin{matrix}G & 0 \\ 0 & G\end{matrix} ] . \qquad ( 15 )$$

However, the Gray code may be redundant for a reduced set of light rays.

To reduce the number of code sets, some embodiments apply a code-projection matrix P that has K₀×Kₚ dimensions, where Kₚ<K₀, to equation (14):

R₀P=A(X₀P). (16)

If the rows of R=R₀P are unique, then X=X₀P is a binary-code-sequence matrix X that satisfies the criteria.

Note that right multiplying corresponds to mixing columns of the binary-code-sequence matrix X, so that this can be roughly described as a form of multiplexing binary patterns on two LMDs that correspond to different bit planes. However, this multiplexing uses binary addition (e.g., XOR) or a linear combination over the binary field F₂.

A brute-force search of the code-projection matrix P may still be computationally expensive. Thus, some embodiments of the measurement system break down the projection into elementary projections along vectors. The projection vectors can be chosen to ensure that, after each projection, each light ray will continue to receive a unique code. This can be repeated until the code-projection space is null.

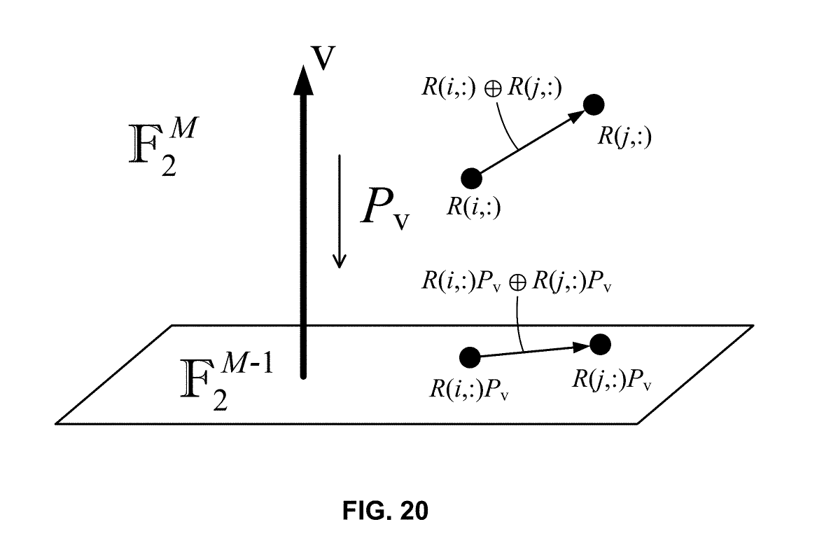

FIG. 20 is a conceptual illustration of the geometry of an example embodiment of a binary-code projection. If v is a row vector in [symbol] ₂^{M}, then the projection matrix Pᵥ along v is an M×(M−1) binary matrix that satisfies vPᵥ=0. Accordingly, the null space ker(Pᵥ)={0,v}, and only the vector v is annihilated. In order for the rows of R₀ to remain unique, none of the pairwise differences of the rows of R₀ can get annihilated by the projection matrix Pᵥ. Let D(R) be the set of pairwise differences of the rows of a binary-code matrix R:

D(R)={R(i,:)⊕R(j, :)|1≦i<j≦l}, (17)

where R(i, :) denotes the i-th row of the binary-code matrix R. Assuming that the binary-code matrix R has unique rows, then 0ΣD(R). Note that over [symbol] ₂, the difference is the same as the sum ⊕. Also, the complement set can be defined according to

\tilde{D}(R)= [symbol] ₂^{M}\({0}∪D(R)). (18)

Thus, any choice of vε\tilde{D}(R) will give a projection matrix P, that preserves the unique rows of the binary-code matrix R. If \acute{D}(R)=Ø, then no such projection is possible. On the other hand, if \tilde{D}(R)≠Ø, then \tilde{D}(R) will usually contain many vectors.

To find an optimal projection vector, some embodiments of the measurement system use a projection vector that will maximize the chance of another projection. Accordingly, some embodiments use a vector v such that \tilde{D}(RP_{V})≠Ø, or such that \tilde{D}(RP_{V}) is a large set. This is formalized by introducing the code sparsity ψ(X; A) of X:

$$ψ ( X ; A ) = \frac{\tilde{D} ( AX )}{{2}^{M} - 1} 100 \% . \qquad ( 19 )$$

A locally-optimal projection is a projection matrix P_{v*} given by a projection vector v* that satisfies

v*=arg max_{vε\tilde{D}(AX)}ψ(xPᵥ;A). (20)

When \tilde{D}(AX) is a large set, searching through its vectors can be very time consuming. Some embodiments of a measurement system implement an approximation to the locally-optimal projection by applying a heuristic filter [symbol] on \tilde{D}(AX) to reduce the size of the search set, as described by the following:

\hat{v}=arg [symbol] ψ(XPᵥ;A). (21)

Let ∥v∥_{H} denote the Hamming weight of a binary vector (i.e., the number of 1's in the vector). Then the minimum-weight filter [symbol] _{minWt} can be described according to

$${ℱ}_{MinWt} ( R ) = \{ v ∈ R \vert {‖ v ‖}_{H} = {min}_{w ∈ R} {‖ w ‖}_{H} \} . \qquad ( 22 )$$

One result of using the minimum-weight filter may be the resulting projection minimally mixes the bit planes and therefore preserves some desirable error-deterrent properties of the Gray code.

The following is a high-level description for obtaining a code for the LMDs: Start with a binary-code sequence matrix X₀= [symbol] ₂^{2N×M}^{₀}, where K₀=2┌log₂ N┐. Find a projection vector \hat{v}₁= [symbol] ₂^{M}^{₀} that maximizes sparsity ω(X₀P_{\hat{v}}_{₁}P_{\hat{v}}_{₂}; A). Then find a projection vector \hat{v}₂ε [symbol] ₂^{M}^{₀}⁻¹ that maximizes sparsity ψ(X₀P_{\hat{v}}_{₁}P_{\hat{v}}_{₂}; A). Repeat, for example for I iterations, until \tilde{D}(AX₀P_{\hat{v}}_{₁}P_{\hat{v}}_{₂} . . . P_{\hat{v}}_{_{I}})=Ø. The optimized binary-code-sequence matrix for the LMDs is then X₀P, where P=P_{\hat{v}}_{₁} P_{\hat{v}}_{₂} . . . P_{\hat{v}}_{_{I}}.

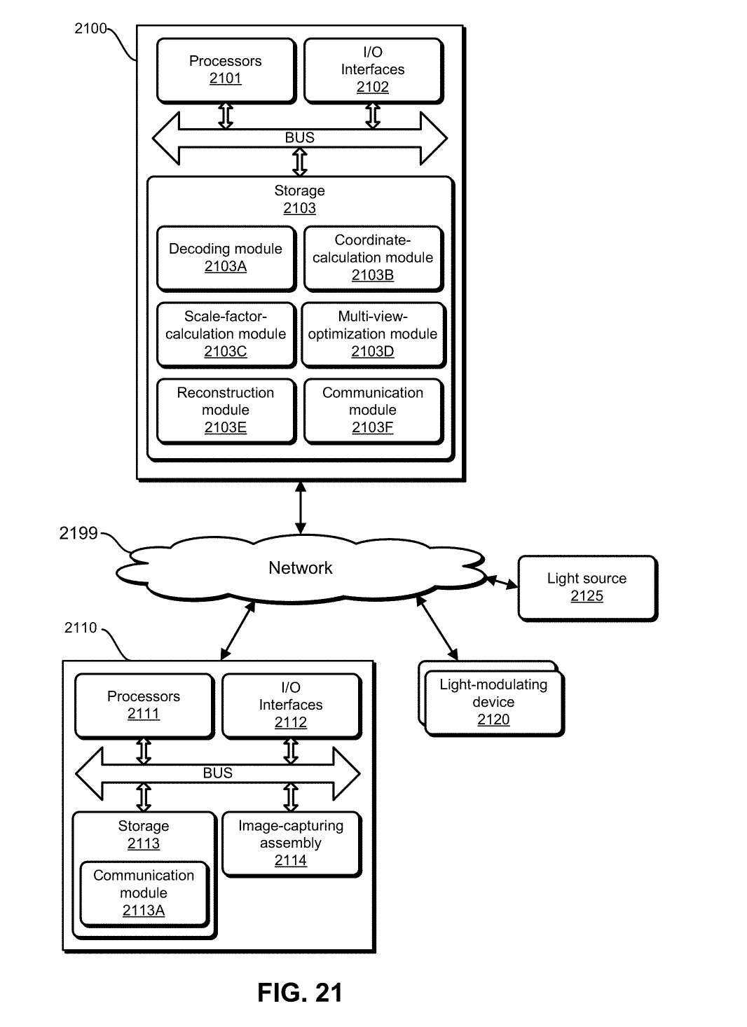

FIG. 21 illustrates an example embodiment of a system for measuring the shapes of objects. The system includes a measurement device 2100, which is a specially-configured computing device; two or more light-modulating devices 2120; a light source 2125; and an image-capturing device 2110. In this embodiment, the devices communicate by means of one or more networks 2199, which may include a wired network, a wireless network, a LAN, a WAN, a MAN, and a PAN. Also, in some embodiments the devices communicate by means of other wired or wireless channels.

The measurement device 2100 includes one or more processors 2101, one or more I/O interfaces 2102, and storage 2103. Also, the hardware components of the measurement device 2100 communicate by means of one or more buses or other electrical connections. Examples of buses include a universal serial bus (USB), an IEEE 1394 bus, a PCI bus, an Accelerated Graphics Port (AGP) bus, a Serial AT Attachment (SATA) bus, and a Small Computer System Interface (SCSI) bus.

The one or more processors 2101 include one or more central processing units (CPUs), which include microprocessors (e.g., a single core microprocessor, a multi-core microprocessor), graphics processing units (GPUs), or other electronic circuitry. The one or more processors 2101 are configured to read and perform computer-executable instructions, such as instructions that are stored in the storage 2103. The I/O interfaces 2102 include communication interfaces for input and output devices, which may include a keyboard, a display device, a mouse, a printing device, a touch screen, a light pen, an optical-storage device, a scanner, a microphone, a drive, a controller (e.g., a joystick, a control pad), and a network interface controller. In some embodiments, the I/O interfaces 2102 also include communication interfaces for the image-capturing device 2110, the two or more light-modulating devices 2120, and the light source 2125.

The storage 2103 includes one or more computer-readable storage media. As used herein, a computer-readable storage medium, in contrast to a mere transitory, propagating signal per se, refers to a computer-readable media that includes a tangible article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). Also, as used herein, a transitory computer-readable medium refers to a mere transitory, propagating signal per se, and a non-transitory computer-readable medium refers to any computer-readable medium that is not merely a transitory, propagating signal per se. The storage 2103, which may include both ROM and RAM, can store computer-readable data or computer-executable instructions.

The measurement device 2100 also includes a decoding module 2103A, a coordinate-calculation module 2103B, a scale-factor-calculation module 2103C, a multi-view-optimization module 2103D, a reconstruction module 2103E, and a communication module 2103F. A module includes logic, computer-readable data, or computer-executable instructions, and may be implemented in software (e.g., Assembly, C, C++, C#, Java, BASIC, Perl, Visual Basic), hardware (e.g., customized circuitry), or a combination of software and hardware. In some embodiments, the devices in the system include additional or fewer modules, the modules are combined into fewer modules, or the modules are divided into more modules. When the modules are implemented in software, the software can be stored in the storage 2103.

The decoding module 2103A includes instructions that, when executed, or circuits that, when activated, cause the measurement device 2100 to decode images and determine LMD-pixel indices, for example as performed in blocks B200 and B201 in FIG. 2 or in blocks B800-6830 in FIG. 8.

The coordinate-calculation module 2103B includes instructions that, when executed, or circuits that, when activated, cause the measurement device 2100 to calculate surface normals (e.g., normal fields) or three-dimensional coordinates (e.g., unscaled surface coordinates, scaled surface coordinates, refined surface coordinates) of points on the surface of an object, for example as performed in blocks B205, B206, B210, B211, B220, B221, and B230 in FIG. 2.

The scale-factor-calculation module 2103C includes instructions that, when executed, or circuits that, when activated, cause the measurement device 2100 to calculate scale factors for single viewpoints, for example as performed in blocks B215 and B216 in FIG. 2.

The multi-view-optimization module 2103D includes instructions that, when executed, or circuits that, when activated, cause the measurement device 2100 to calculate refined scale factors, for example as performed in block B225 in FIG. 2 or as described by equation (10).

The reconstruction module 2103E includes instructions that, when executed, or circuits that, when activated, cause the measurement device 2100 to generate merged surface coordinates, for example as performed in block B235 in FIG. 2.

The communication module 2103F includes instructions that, when executed, or circuits that, when activated, cause the measurement device 2100 to communicate with one or more other devices, for example the image-capturing device 2110, the two or more light-modulating devices 2120, and the light source 2115.

The image-capturing device 2110 includes one or more processors 2111, one or more I/O interfaces 2112, storage 2113, a communication module 2113A, and an image-capturing assembly 2114. The image-capturing assembly 2114 includes one or more image sensors, one or more lenses, and an aperture. The communication module 2113A includes instructions that, when executed, or circuits that, when activated, cause the image-capturing device 2110 to communicate with the measurement device 2100. The communication may include receiving a request to capture an image, receiving a request to send a captured image, and retrieving a requested image from the storage 2113 and sending the retrieved image to the measurement device 2100.

At least some of the above-described devices, systems, and methods can be implemented, at least in part, by providing one or more computer-readable media that contain computer-executable instructions for realizing the above-described operations to one or more computing devices that are configured to read and execute the computer-executable instructions. The systems or devices perform the operations of the above-described embodiments when executing the computer-executable instructions. Also, an operating system on the one or more systems or devices may implement at least some of the operations of the above-described embodiments.

Furthermore, some embodiments use one or more functional units to implement the above-described devices, systems, and methods. The functional units may be implemented in only hardware (e.g., customized circuitry) or in a combination of software and hardware (e.g., a microprocessor that executes software).

The scope of the claims is not limited to the above-described embodiments and includes various modifications and equivalent arrangements. Also, as used herein, the conjunction “or” generally refers to an inclusive “or,” though “or” may refer to an exclusive “or” if expressly indicated or if the context indicates that the “or” must be an exclusive “or.”

What is claimed is:

1. A method comprising:
obtaining two sets of images of an object, each of which was captured from a respective viewpoint, wherein the viewpoints partially overlap;
identifying pixel regions in the two sets of images that show reflections from a light-modulating device that were reflected by a surface of the object;
calculating respective surface normals for points on the surface of the object in the pixel regions in the two sets of images, wherein at least some of the points on the surface of the object are shown in both of the two sets of images;
calculating, for each viewpoint of the two viewpoints, respective unscaled surface coordinates of the points on the surface of the object based on the respective surface normals;
calculating, for each viewpoint of the two viewpoints, a respective initial scale factor based on the respective surface normals and on decoded light-modulating-device-pixel indices;
calculating, for each viewpoint of the two viewpoints, initial scaled surface coordinates of the points on the surface of the object based on the respective initial scale factor of the viewpoint and the respective unscaled surface coordinates of the viewpoint; and
calculating, for each viewpoint of the two viewpoints, a respective refined scale factor by minimizing discrepancies among the initial scaled surface coordinates of the points on the surface of the object that are shown in both of the two sets of images.

2. The method of claim 1, further comprising:
calculating, for each viewpoint of the two viewpoints, respective refined scaled surface coordinates of the points on the surface of the object based on the respective unscaled scaled surface coordinates of the points on the surface of the object and on the respective refined scale factor.

3. The method of claim 2, further comprising:
generating a representation of a shape of the object based on the respective refined scaled surface coordinates of the two viewpoints.

4. The method of claim 1, wherein calculating, for each viewpoint of the two viewpoints, the respective initial scale factor includes ray tracing from an image-capturing device to a light-modulating device.

5. The method of claim 1, wherein calculating the respective surface normals for points on the surface of the object in the pixel regions in the two sets of images includes calculating respective light-modulating-device-pixel indices for each pixel in the pixel regions in the two sets of images, wherein the light-modulating-device-pixel indices for a pixel in the pixel regions indicate a light-modulating-device pixel from a first light-modulating device and a light-modulating-device pixel from a second light-modulating device.

6. The method of claim 1, wherein calculating the respective refined scale factors by minimizing discrepancies among the initial scaled surface coordinates of the points on the surface of the object that are shown in both of the two sets of images includes, for each of the points on the surface of the object that are shown in both of the two sets of images,
calculating a difference in location between the initial scaled surface coordinates of the point in one of the viewpoints and the initial scaled surface coordinates of the point in an other of the viewpoints.

7. The method of claim 6, wherein calculating the respective refined scale factors by minimizing discrepancies among the initial scaled surface coordinates of the points on the surface of the object that are shown in both of the two sets of images includes, for each of the points on the surface of the object that are shown in both of the two sets of images,
calculating a difference in a surface-normal angle between the surface normal of the point in one of the viewpoints and the surface normal of the point in the other of the viewpoints.

8. A system comprising:
one or more computer-readable media; and
one or more processors that are coupled to the one or more computer-readable media and that are configured to cause the system to
obtain a first set of images of an object that was captured from a first viewpoint,
obtain a second set of images of the object that was captured from a second viewpoint,
calculate first respective surface normals for points on a surface of the object that are shown in the first set of images,
calculate second respective surface normals for points on the surface of the object that are shown in the second set of images, wherein at least some of the points on the surface of the object are shown in both the first set of images and the second set of images,
calculate, for each viewpoint of the two viewpoints, respective unscaled surface coordinates of the points on the surface of the object based on the respective surface normals;
calculate, for the first viewpoint, first initial scaled surface coordinates of the points on the surface of the object that are shown in the first set of images based on the first respective surface normals and on a first initial scale factor,
calculate, for the second viewpoint, second initial scaled surface coordinates of the points on the surface of the object that are shown in the second set of images based on the second respective surface normals and on a second initial scale factor, and
calculate a first refined scale factor and a second refined scale factor by minimizing differences between the first initial scaled surface coordinates and the second initial scaled surface coordinates of the points on the surface of the object that are shown in both the first set of images and the second set of images.

9. The system of claim 8, wherein, to calculate the first respective surface normals for the points on the surface of the object that are shown in the first set of images, the one or more processors are further configured to cause the system to
calculate respective light-modulating-device-pixel indices for pixels in the first set of images that show the points on the surface of the object, wherein the light-modulating-device-pixel indices for a pixel in the first set of images identify a light-modulating-device pixel from a first light-modulating device and a light-modulating-device pixel from a second-light modulating device.

10. The system of claim 9, wherein, to calculate the first initial scaled surface coordinates of the points on the surface of the object that are shown in the first set of images, the one or more processors are further configured to cause the system to
calculate first unscaled surface coordinates of the points on the surface of the object that are shown in the first set of images based on the first respective surface normals for the points on the surface of the object that are shown in the first set of images.

11. The system of claim 10, wherein, to calculate the first initial scaled surface coordinates of the points on the surface of the object that are shown in the first set of images, the one or more processors are further configured to cause the system to
calculate the first initial scale factor based on the light-modulating-device-pixel indices for the pixels in the first set of images that show the points on the surface of the object and on the first unscaled surface coordinates of the points on the surface of the object that are shown in the first set of images.

12. The system of claim 8, wherein, to calculate the first refined scale factor and the second refined scale factor, the one or more processors are further configured to cause the system to
select a first candidate scale factor for the first set of images,
select a second candidate scale factor for the second set of images,
rescale the first initial scaled surface coordinates using the first candidate scale factor, thereby generating first candidate surface coordinates,
rescale the second initial scaled surface coordinates using the second candidate scale factor, thereby generating second candidate surface coordinates, and
calculate differences between the first candidate surface coordinates and the second candidate surface coordinates.

13. The system of claim 8, wherein the one or more processors are further configured to cause the system to
calculate, for the first viewpoint, first refined scaled surface coordinates of the points on the surface of the object that are shown in the first set of images based on the respective unscaled surface coordinates and on the first refined scale factor; and
calculate, for the second viewpoint, second refined scaled surface coordinates of the points on the surface of the object that are shown in the second set of images based on the respective unscaled surface coordinates and on the second refined scale factor.

14. One or more computer-readable storage media that store computer-executable instructions that, when executed by one or more computing devices, cause the one or more computing devices to perform operations comprising:
obtaining a first set of images of an object that was captured from a first viewpoint;
obtaining a second set of images of the object that was captured from a second viewpoint;
calculating first respective surface normals for points on a surface of the object that are shown in the first set of images;
calculating second respective surface normals for points on the surface of the object that are shown in the second set of images, wherein at least some of the points on the surface of the object are shown in both the first set of images and the second set of images;
calculating, for the first viewpoint, first initial scaled surface coordinates of the points on the surface of the object that are shown in the first set of images based on the first respective surface normals and on a first initial scale factor;
calculating, for the second viewpoint, second initial scaled surface coordinates of the points on the surface of the object that are shown in the second set of images based on the second respective surface normals and on a second initial scale factor; and
calculating a first refined scale factor and a second refined scale factor by minimizing differences between the first initial scaled surface coordinates and the second initial scaled surface coordinates of the points on the surface of the object that are shown in both the first set of images and the second set of images.

15. The one or more computer-readable media of claim 14, wherein the operations further comprise:
calculating first refined scaled surface coordinates of the points on the surface of the object that are shown in the first set of images based on first unscaled surface coordinates of the points on the surface of the object and on the first refined scale factor; and
calculating second refined scaled surface coordinates of the points on the surface of the object that are shown in the second set of images based on second unscaled surface coordinates of the points on the surface of the object and on the second refined scale factor.

16. The one or more computer-readable media of claim 15, wherein the operations further comprise:
generating a representation of a shape of the object based on the first refined scaled surface coordinates and on the second refined scaled surface coordinates.

17. The one or more computer-readable media of claim 16, wherein the representation of the shape of the object is a point cloud.

18. The one or more computer-readable media of claim 16, wherein generating the representation of the shape of the object includes transforming the first refined scaled surface coordinates and the second refined scaled surface coordinates into a common coordinate system.

19. The one or more computer-readable media of claim 14,
wherein the first initial scaled surface coordinates of the points on the surface of the object define a first surface as seen from the first viewpoint,
wherein the second initial scaled surface coordinates of the points on the surface of the object define a second surface as seen from the second viewpoint, and
wherein calculating the first refined scale factor and the second refined scale factor by minimizing differences between the first initial scaled surface coordinates and the second initial scaled surface coordinates of the points on the surface of the object that are shown in both the first set of images and the second set of images can be described by the following objective function:
ε(α_{ω},α_{ω′})=d_{C}_{⁰}(Rᵢ⁻¹(α_{ω}W_{ω}−Tᵢ),Rⱼ⁻¹(α_{ω′}W_{ω′}−Tᵢ))+d_{C}_{¹}(Rᵢ⁻¹(α_{ω}W_{ω}−Tᵢ),Rⱼ⁻¹(α_{ω′}W_{ω′}−Tⱼ)),
where ω is the first surface, where ω′ is the second surface, where i is an index for the first viewpoint, where j is an index for the second viewpoint, where d_{C}_{⁰} measures topological closeness between the first surface co and the second surface co′, where d_{C}_{¹} measures closeness in the tangent space of the first surface co and the second surface ω′, where W_{ω}is a window of the first surface from the first viewpoint, where W_{ω′} is a window of the second surface from the second viewpoint, where T is a translation matrix, where R is a rotation matrix, where the combination of R and T constitutes a complete transformation, where α_{ω} is the first scale factor, and where α_{ω′} is the second scale factor.
